(19) United States
(12) Patent Application Publication
(10) Pub. No.: US 2026/0147887 A1
(43) Pub. Date: May 28, 2026

(54) Computer-Automated Systems and Methods for Cross-Platform Code Threat Detection

(71) Applicant: StartOS Inc., New Providence, NJ (US)

(72) Inventor: Jason Nichols, New Providence, NJ (US)

(73) Assignee: StartOS Inc., New Providence, NJ (US)

(21) Appl. No.: 19/402,637

(22) Filed: Nov. 26, 2025

Related U.S. Application Data
(60) Provisional application No. 63/726,073, filed on Nov. 27, 2024.

(51) Int. Cl. G06F 21/55

(52) U.S. Cl. CPC G06F 21/554; G06F 2221/033

(57) ABSTRACT

A computer-implemented method for detecting malicious code across different programming languages receives input source code, generates semantic embeddings for the input code and cross-language generated code, compares the embeddings to produce a comparison result, and analyzes the result to identify potential malicious code. The method leverages semantic analysis techniques and language-specific embedding models to enable efficient and accurate detection of security threats across language boundaries. By focusing on the semantic essence of the code rather than its literal text representation, the method overcomes limitations of traditional malicious code detection approaches, providing a robust, scalable, and secure solution for managing code security in multi-language software development environments.

### CROSS-REFERENCE TO RELATED APPLICATIONS

This application claims the benefit of priority of U.S. Provisional Ser. No. 63/726,073 , filed Nov. 27, 2024, the contents of which are incorporated herein by reference in their entirety.

### BACKGROUND

The proliferation of malicious code across various programming languages has posed significant challenges to cybersecurity efforts. Traditional approaches to malware detection have often been language-specific, focusing on identifying threats within a single programming language or environment. However, as cyber threats become increasingly sophisticated and diverse, there is a growing need for more comprehensive and adaptable detection methods.

Existing malware detection systems typically rely on signature-based methods, behavioral analysis, or machine learning techniques applied to specific programming languages. While these approaches have shown some success, they are often limited in their ability to detect novel or cross-language threats. Signature-based methods, for instance, struggle to identify previously unknown malware variants, while behavioral analysis may fail to capture the nuances of malicious code implemented across different languages.

Furthermore, the rapid evolution of programming languages and development frameworks has created a complex landscape where malicious actors can exploit the differences and incompatibilities between languages to evade detection. This has led to a significant gap in the ability of current systems to provide comprehensive protection against malware.

Another limitation of existing approaches is their reliance on language-specific features or syntax, which makes it challenging to transfer knowledge and detection capabilities across different programming languages. This lack of transferability often results in the need for separate detection systems for each language, leading to increased complexity, maintenance overhead, and potential security gaps.

The increasing use of multi-language software projects and the growing trend of language interoperability have further exacerbated these challenges. Malicious code can now span multiple languages within a single application, making it even more difficult for traditional, language-specific detection methods to identify and mitigate threats effectively.

Additionally, the volume and variety of code being produced and shared across global development communities have outpaced the ability of manual analysis and traditional automated tools to keep up with potential security threats. This has created a pressing need for more scalable and efficient methods of analyzing and comparing code across different programming languages.

In light of these challenges, there is a clear and urgent need for innovative approaches to malicious code detection that can transcend the boundaries of individual programming languages, provide more robust and adaptable threat identification capabilities, and offer scalable solutions for the ever-growing and diverse landscape of modern software development.

### SUMMARY

One embodiment of the present invention relates to a computer-automated system and method for detecting malicious code across different programming languages. The system receives input source code, generates transformed code and embeddings based on the input code or natural language, produces cross-language code in a different programming language, and compares semantic embeddings to identify potential malicious code.

The system includes: an embedding module that generates semantic embeddings for both the input code and cross-language generated code; a cross-language code generation module that translates the input code into a different programming language; a semantic comparison module that compares the embeddings of the original and cross-language code to produce a comparison result; and analysis components that evaluate the comparison result to detect indicators of malicious code, such as semantic inconsistencies, known malicious patterns, or anomalies.

The system leverages semantic analysis techniques and embedding models trained for specific programming languages to enable efficient and accurate detection of malicious code across language boundaries. This approach addresses limitations of traditional malicious code detection methods by focusing on the semantic essence of the code rather than its literal text representation. By transforming source code into high-dimensional vector embeddings, the system achieves a higher level of precision in identifying potential security threats. The system is particularly suited for use in environments in which large volumes of code need to be analyzed quickly and accurately.

Embodiments of the invention provide a robust, scalable, and secure solution for managing code security and compliance in multi-language software development environments, offering significant improvements over traditional text-based or hash-based comparison methods for malicious code detection.

Other features and advantages of various aspects and embodiments of the present invention will become apparent from the following description and from the claims.

### BRIEF DESCRIPTION OF THE DRAWINGS

FIG. 1 is a dataflow diagram of a system for ingesting source data according to one embodiment of the present invention.

FIG. 2 is a flowchart of a method performed by the system of FIG. 1 according to one embodiment of the present invention.

FIG. 3 is a dataflow diagram of a system for analyzing source code to detect copyrighted code within that source code according to one embodiment of the present invention.

FIG. 4 is a flowchart of a method performed by the system of FIG. 3 according to one embodiment of the present invention.

FIG. 5 is a dataflow diagram of a system for performing cross-language malicious code detection according to one embodiment of the present invention.

FIG. 6 is a flowchart of a method performed by the system of FIG. 5 according to one embodiment of the present invention.

### DETAILED DESCRIPTION

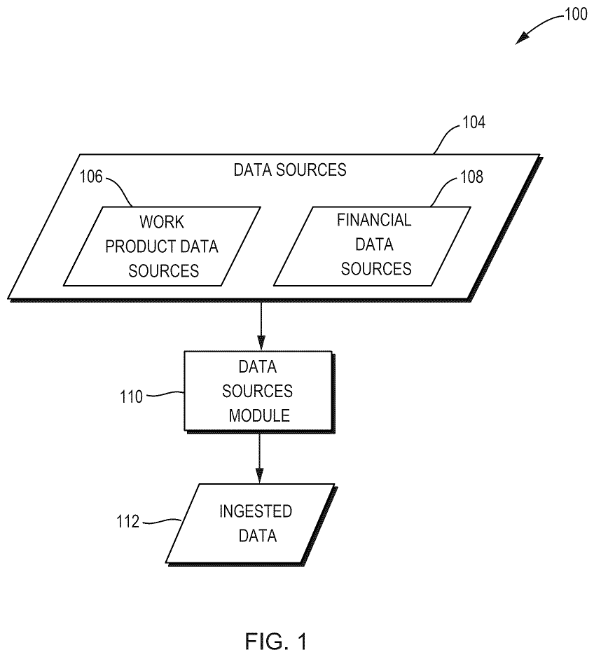

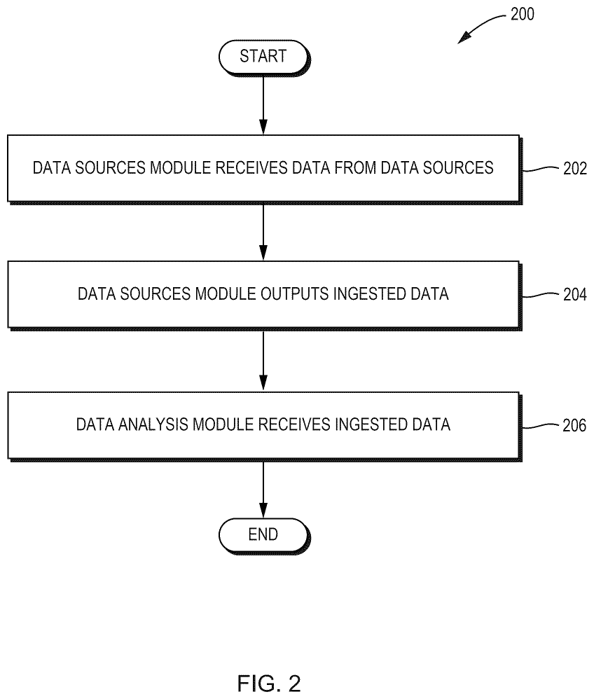

Referring to FIG. 1, a dataflow diagram is shown of a system 100 for ingesting source data according to one embodiment of the present invention. Referring to FIG. 2, a flowchart is shown of a method 200 performed by the system 100 according to one embodiment of the present invention.

The system 100 includes a plurality of data sources 104. The plurality of data sources 104 may, for example, include a work product data source 106 and a financial data source 108. The work product data source 106 may include any of a variety of data generated by and/or associated with one or a plurality of workers. As an example, the work product data source 106 may include source code written, generated by, and/or otherwise associated with one or a plurality of software developers. As will be described in more detail below, the work product data source 106 may include metadata which may associate work product (e.g., source code) within the work product data source 106 with one or more corresponding workers (e.g., the worker(s) who created (e.g., wrote) that work product). Although the work product data source 106 is referred to herein as a data “source,” in practice the work product data source 106 may include one or a plurality of data sources.

The work product data source 106, which includes source code, can be implemented using various data sources at different levels of abstraction. These data sources range from high-level platforms to more detailed, specific tools that manage and store source code. Below are examples at high, medium, and low levels of abstraction, including popular commercial platforms that could be used to implement the work product data source 106.

At a high level, the work product data source 106 may be any system that stores and/or serves outputs (e.g., digital data) created by one or more workers. In the context of workers who are software developers, this may include, for example:
Integrated Development Environments (IDEs): While primarily used for coding, IDEs often have local history features that can serve as a source of work product data.
Cloud-Based Development Platforms: Platforms like AWS Cloud9 or Microsoft Visual Studio Online, which not only provide coding environments but also store versions of the code being developed.

More specifically, the work product data source 106 may include one or more systems designed for version control and/or collaborative coding, which are used for tracking changes and contributions by individual developers. Examples of these include:
Version Control Systems (VCS): These are tools specifically designed to manage changes to documents, programs, and other information stored as files.
Git: A distributed version control system that handles everything from small to very large projects with speed and efficiency.
Subversion (SVN): A centralized version control system that records changes to files and directories over time.

Even more specifically, the work product data source 106 may, for example, be implemented using specific instances or deployments of version control systems, configured for particular organizational needs. Examples of these include GitHub, GitLab, and Bitbucket.

The work product data source 106 may include any of a variety of data types that are relevant to assessing the productivity and contributions of software developers. An example is the inclusion of data from ticketing systems, such as those which are commonly used in customer support and project management contexts. The work product data source 106 may include data from customer support ticketing systems and/project management ticketing systems. Data from customer support ticketing systems can provide insights into how software developers interact with end-users, manage and resolve issues, and contribute to customer satisfaction and product improvement. This data may include records of bug reports, feature requests, user feedback, and the developers'responses and resolutions. Including this data allows the system 100 to assess the impact of developers on customer relations and product reliability, which are crucial metrics for evaluating developer effectiveness and the quality of the software.

Data from project management ticketing systems typically includes information on task assignments, progress updates, completion statuses, and time logs related to specific development projects or tasks. This data helps in tracking the contributions of individual developers to various projects, their efficiency in handling tasks, and their ability to meet deadlines and project goals. By analyzing this data, the system 100 can generate detailed insights into the productivity, work habits, and project impact of software developers, facilitating a comprehensive evaluation of their performance.

Incorporating data from ticketing systems into the work product data source 106 provides several advantages, such as enabling a more holistic assessment of a developer's role and effectiveness across different aspects of software development, from coding to customer interaction and project management. Incorporating ticketing system data also offers enhanced visibility into the day-to-day operations and challenges faced by developers, providing context that can be crucial for understanding productivity metrics and developmental outcomes. Furthermore, the integration of diverse data sources like ticketing systems facilitates richer, data-driven insights into developer performance, supporting better-informed decision-making processes regarding promotions, training needs, and project assignments.

The financial data source 108 may include any of a variety of financial data associated with one or a plurality of workers, such as the workers who are associated with the work product data source 106. The financial data source 108. As will be described in more detail below, the system 100 may use the data in the financial data source 108 to calculate and assess the financial productivity and efficiency of the workers, particularly in relation to the value of the work products they generate. Although the financial data source 108 is referred to herein as a data “source,” in practice the financial data source 108 may include one or a plurality of data sources.

The financial data source 108 may, for example, include payroll data which details the compensation paid to the workers who created the data in the work product data source 106 for their contributions to that work product. By integrating this financial data with the technical data from the work product data source 106, the system 100 may perform nuanced analyses that reveal insights into cost-effectiveness and return on investment (ROI) for each worker's contributions. Such payroll data may, for example, include data representing the salaries, bonuses, and/or other forms of compensation paid to the workers. This data helps in understanding the direct financial costs associated with the production of the work product created by the workers

The financial data source 108 may include data representing additional financial benefits provided to the workers, such as health insurance, stock options, and retirement plans, which contribute to the total cost of employment. The financial data source 108 may include financial data related to specific projects or tasks that workers are involved in, which might include allocated budgets, actual spending, and financial outcomes of projects. The financial data source 108 may include performance-related financial metrics, such as data that links financial rewards to specific performance metrics or outcomes, such as bonuses based on project success or revenue generated from a product developed by the workers.

In addition to compensation-related data, the financial data source 108 may also encompass data related to the costs of hosting and maintaining software systems in cloud environments, as well as utilization metrics such as CPU and memory usage. This data may, for example, be sourced from various cloud service providers and integrated into the system 100. Including utilization metrics provides a more granular view of resource consumption, which is essential for guiding cost discussions and optimizing cloud resource allocation.

By incorporating both cost and utilization data, the system 100 may deliver comprehensive insights into the total cost of ownership (TCO) of software projects. This analysis is crucial for stakeholders as it aids in making well-informed decisions regarding resource allocation, budgeting, and the financial viability of employing cloud technologies in software development processes. Understanding the interplay between resource utilization and associated costs allows organizations to strategically manage their cloud infrastructure, ensuring that they are not only meeting their developmental needs but also doing so in a cost-effective manner.

The financial data source 108 may be implemented in any of a variety of ways. For example, at a high level, the financial data source 108 may include any kind of financial management system that aggregates and analyzes financial data across an organization. The financial data source 108 may include, for example, an Enterprise Resource Planning (ERP) systems, which integrates various functions including finance, HR, and operations, providing a holistic view of the financial data related to workers, such as SAP ERP or Oracle NetSuite.

The financial data source 108 may include a Human Resources Information System (HRIS), which is a system that manages employee data, including payroll, benefits, and compensation. Examples of HRIS systems are Workday and BambooHR. The financial data source 108 may include a payroll system, which is a dedicated system that manages the payment of wages and salaries. Examples of payroll systems include ADP and Paychex.

More specifically, the financial data source 108 may be implemented using specific tools or software solutions that handle detailed financial transactions and reporting, such as accounting software (e.g., QuickBooks or Xero) and/or project costing tools (e.g., Microsoft Project, Smartsheet).

The financial data source 108 may include or obtain data from one or more banks. This integration allows the system 100 to access real-time financial transactions, account balances, and other relevant financial information associated with the workers. By linking directly with banking institutions, the financial data source 108 can automatically pull detailed compensation data, such as salaries, bonuses, and other forms of direct monetary compensation that are processed through these banks. This direct link ensures that the data in the financial data source 108 is accurate, up-to-date, and reflective of the actual financial transactions occurring in relation to the workers.

The financial data source 108 may also include or obtain data from one or more cryptocurrency wallets. As workers may receive parts of their compensation in cryptocurrencies, or may engage in transactions relevant to their employment using digital currencies, it may be helpful for the financial data source 108 to capture this aspect of financial activity. By linking to cryptocurrency wallets, the system 100 can track and analyze transactions made in cryptocurrencies, including the receipt of digital assets as part of compensation packages or payments for specific projects or tasks.

The system 100 also includes a data sources module 110. In general, the data sources module 110 receives data from the plurality of data sources 104 (e.g., the work product data source 106 and/or the financial data source 108) (FIG. 2, operation 202) and processes such data to produce ingested data 112 as output (FIG. 2, operation 204). A variety of techniques that the data sources module 110 may use to receive data from the plurality of data sources 104 and to generate the ingested data 112 will be described below. Although the data sources module 110 may generate data based on the data received from the plurality of data sources 104, such that the ingested data 112 may include generated data which was not present in the plurality of data sources 104, the ingested data ingested data 112 may also include data which was present in the plurality of data sources 104.

The data sources module 110 may receive the data from the plurality of data sources 104 in any of a variety of ways. For example, the system 100 may execute an invitation process that is a preliminary step which facilitates the subsequent data exchange between a requester (e.g., an investor) and a target (e.g., a company in which the investor is considering investing). For example, the invitation process may begin when an investor (referred to more generally herein as a “requester”) identifies a potential investment or acquisition target. To initiate due diligence or further engagement, the requester may send an electronic invitation to the target company. This invitation may be the first step in establishing a data-sharing relationship that will allow the requester to assess the target's value accurately.

The invitation process may be implemented using various computerized methods, ensuring efficiency, traceability, and security. For example, the invitation process may include sending an invitation via email. This can be done using standard email services or through a more secure, encrypted email system if confidentiality is a concern. As another example, a specialized platform may facilitate the invitation process by providing structured workflows for sending invitations, tracking responses, and managing subsequent data exchanges. As yet another example, a custom web portal may be used to guide the requester through the necessary steps to formally issue an invitation, ensuring all required information is provided. As yet another example, one or more application program interfaces (APIs) may be used to integrate the invitation process with other business systems (e.g., CRM systems), thereby automating the invitation process based on certain triggers or business rules.

Given the potentially sensitive nature of the information exchanged following the invitation, any of a variety of security measures may be implemented to maintain the security of sensitive data. This may include, for example, using secure transmission protocols (e.g., HTTPS, SSL/TLS), data encryption, and/or digital signatures to authenticate the identity of the parties involved.

The target may accept the invitation from the requester in any of a variety of ways. For example, the target may send a confirmation email back to the requester to accept the invitation. Such an invitation may include any text which indicates acceptance of the invitation. As another example, and to ensure the authenticity and non-repudiation of the acceptance, one or more digital signatures may be used to implement the target's acceptance of the invitation, such as by the target signing a digital document that formally accepts the invitation. If the requester has a dedicated portal for managing investments or acquisitions, the target may log in to this portal and formally accept the invitation through a user interface designed for this purpose. For organizations that use enterprise resource planning (ERP) or customer relationship management (CRM) systems, the acceptance may be recorded and managed within these systems. One or more APIs may be used to automate the acceptance process, especially when integrating with other systems, such as CRM or ERP. The target may trigger an API call that records the acceptance in both the requester's and the target's systems. Secure messaging platforms that comply with industry standards may be used to send and receive acceptance notifications. Such platforms offer end-to-end encryption, ensuring that the acceptance is communicated securely.

After the target accepts the invitation from the requester, the target may select a pre-existing account of the target with the requester or create a new account. In either case, the target's account will facilitate further interactions and data exchanges between the requester and the target. This account serves as a centralized repository for information associated with the target, streamlining communication and ensuring that all necessary data is readily accessible for due diligence or other evaluative processes. The system 100 may, for example, prompt the target to create an account on the requester's platform or system, such as through a dedicated web portal, a third-party service, or directly within an enterprise system. During account creation, the target may be required to provide basic information such as company name, contact details, and other relevant organizational details. Security measures such as setting up a strong password, multi-factor authentication, and security questions may be used during this phase to protect the account.

As mentioned above, the data sources module 110 retrieves data from the plurality of data sources 104. The data sources module 110 may use any of a variety of methods to retrieve data from the plurality of data sources 104, each tailored to meet specific security and operational needs. In one such method, the data sources module 110 establishes a link to the target's data sources 104 and retrieves data from the plurality of data sources 104 via that link. The data sources module 110 may establish the link using any of a variety of techniques, such as by using OAuth or a similar technology.

This link-based approach allows the data sources module 110 to extract necessary data without requiring direct access to the target's data environment. By doing so, it ensures that the data sources module 110, as well as the requester more generally, do not interact directly with the sensitive internal systems of the target (e.g., the plurality of data sources 104). This method not only enhances the security of the data exchange by minimizing potential exposure but also maintains the integrity and confidentiality of the target's data sources. This embodiment is especially crucial in scenarios where data sensitivity and privacy are paramount, providing a secure bridge to access required data while upholding stringent security standards.

The plurality of data sources 104 may, for example, be located within one or more computer systems of the target, and the data sources module 110 may be located within one or more computer systems of the requester. The computer systems of the target and the computer systems of the requester may be physically and/or logically distinct from each other. For example, the computer systems of the target and the computer systems of the requester may be on different networks (e.g., Local Area Networks) from each other. As this implies, the plurality of data sources 104 and the data sources module 110 may be on different networks from each other.

In an alternative embodiment of the system, the data sources module 110 may use an agent-based approach, in which a specialized software agent is installed on the target's computer systems. The target may, for example, download the agent from the requester's computers and install the agent locally. The agent may be specifically designed to interact with the target's data sources 104, retrieve necessary data, and securely upload it to the data sources module 110, which in this scenario, may function as a server located outside the target's environment.

The agent may have the capability to query, collect, and process data from the plurality of data sources 104. This might involve, for example, accessing databases, file systems, and/or other data repositories. Before transmission to the data sources module 110, the agent may preprocess the data to conform to the formats and structures required by the data sources module 110. This might include data normalization, encryption, and/or compression. As another example, the agent may summarize and/or filter data from the plurality of data sources 104 and provide only the resulting summarized and/or filtered data to the data sources module 110. The agent may securely upload the processed data to the data sources module 110 using encrypted channels to ensure data integrity and confidentiality.

Both the link-based (e.g., OAuth) and agent-based approaches offer distinct methods for retrieving data from the plurality of data sources 104 and providing the retrieved data to the data sources module 110. Each has its advantages and disadvantages, depending on the specific requirements and constraints of the target's environment. For example, benefits of the link-based approach include not requiring the installation of additional software on the target's systems, reducing the complexity of setup and maintenance; easy scalability by providing the ability to handle multiple data sources and targets without significant changes to the target's infrastructure; reduced load on the targets systems; and flexibility in adding new data sources. Advantages of the agent based approach include enhanced security as a result of processing data locally within the target's environment; the ability to customize the agent to meet the unique data needs and security requirements of the target; enabling data to be retrieved offline; and providing the target with greater control over the data, which can be crucial for compliance with stringent data protection regulations. A particular benefit of the agent-based approach is that it may be used to provide to the data sources module 110 only data from the plurality of data sources 104 which are necessary for the other components of the system 100 to perform the functions described below. In this way, the benefits of the system 100 may be obtained in a way that exposes the minimal amount of data necessary from the target (e.g., the plurality of data sources 104) to the requester (e.g., the data sources module 110).

Both the link-based and agent-based embodiments provide the benefit of enabling the data sources module 110 to obtain data automatically from the plurality of data sources 104, thereby reducing or eliminating the need for the target to manually enter data into the data sources module 110.

Although the link-based and agent-based approaches are described herein as alternatives to each other, embodiments of the present invention may use both approaches in any combination.

The data sources module 110 may normalize any of the data retrieved from the plurality of data sources 104 and store the original retrieved data and/or normalized data in a data store of any suitable type. Any of the functions that are described herein as being performed on the retrieved data may be performed on the pre-normalized retrieved data and/or on the normalized retrieved data. As this implies, the ingested data 112 may include the pre-normalized retrieved data and/or the normalized retrieved data. Normalization performed by the data sources module 110 may include, for example, any one or more of the following:
Data Cleaning: Initial cleaning of data to remove duplicates, correct errors, and handle missing values.
Standardization: Converting data into a uniform format, which may involve standardizing date formats, units of measurement, or string formatting (e.g., capitalization).
Scaling: Adjusting data scales so that they are consistent across different sources. For example, converting all currency values to a single currency or normalizing financial figures to a common scale.
Encoding: Transforming categorical data into numerical formats that can be used in mathematical calculations and machine learning models.

One embodiment of the present invention relates to a computer-automated system and method for identifying copyrighted source code embedded within other source code files, utilizing advanced semantic analysis techniques. This embodiment of the invention addresses the challenge of detecting both literal and non-literal copies of copyrighted code, including instances where the code has been modified in non-semantic ways, such as through renaming variables, changing formatting, or rearranging code blocks. This embodiment creates semantic embeddings of source code using, for example, a language model (e.g., a large language model or a small language model) or other artificial neural network. Each segment of source code is transformed into a high-dimensional vector that captures its semantic essence, rather than its literal text. These vectors are then compared using sophisticated similarity metrics, such as cosine similarity or L2 distance, to determine the likelihood of copyright infringement. This embodiment can operate without direct access to the full source code, thereby enhancing privacy and security. Instead, the system works with embeddings that represent the semantic information of the code, significantly reducing the risk of data exposure. Additionally, this embodiment of the invention may include a compression module that further minimizes the data footprint by compressing the semantic vectors, enhancing the system's efficiency and scalability. This embodiment of the invention is particularly suited for use in environments where large volumes of code need to be analyzed quickly and accurately, such as in continuous integration/continuous deployment (CI/CD) pipelines. It provides a robust, scalable, and secure solution for managing copyright compliance in software development, offering significant improvements over traditional text-based or hash-based comparison methods.

The ingested data 112 produced by the system 100 may be provided to various downstream analysis modules for further processing and analysis (FIG. 2, operation 206). For example, when the ingested data 112 includes source code from the work product data source 106, this data may be provided to specialized analysis systems designed to detect security vulnerabilities, identify copyrighted content, or perform other types of code analysis. The following embodiments describe specific implementations of such analysis modules that may receive and process the ingested data 112 to provide valuable insights for various applications, including investment due diligence, security assessment, and intellectual property protection.

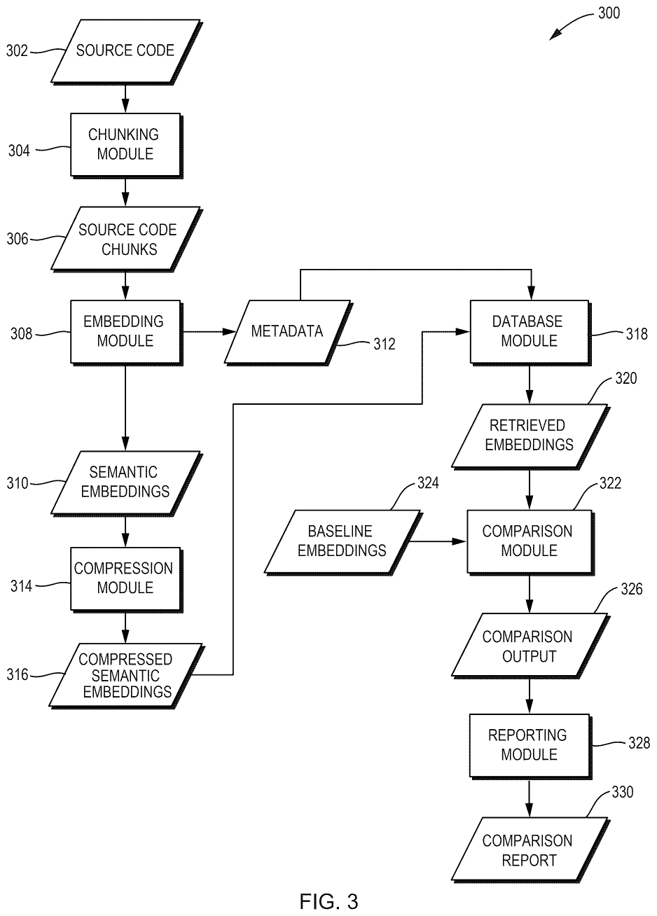

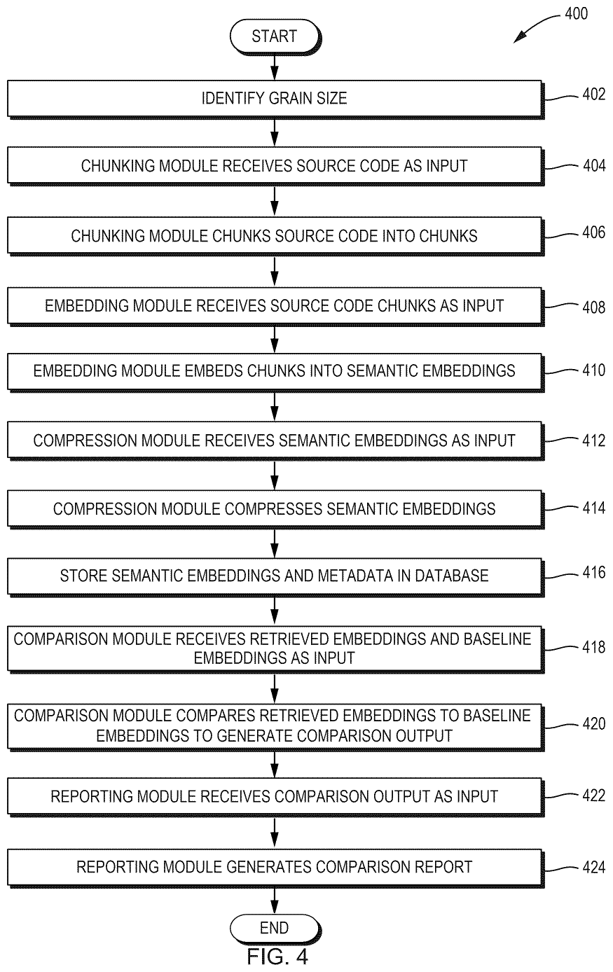

Referring to FIG. 3, a dataflow diagram is shown of a system 300 for analyzing source code to detect copyrighted code within that source code according to one embodiment of the present invention. Referring to FIG. 4, a flowchart is shown of a method 400 performed by the system 300 according to one embodiment of the present invention.

The system 300 includes source code 302, which may, for example, be part of the work product data source 106 as illustrated in system 100 of FIG. 1. As detailed below, system 300 is designed to determine whether the source code 302 contains any “reference source code.” Herein, “reference source code” refers to any code that is subject to comparison against source code 302, including but not limited to code that is copyrighted or otherwise restricted. Reference source code may encompass source code that is not licensed for use by the owner or licensee of source code 302. This could include, for example, source code protected by one or more intellectual property rights such as copyright, patent, and/or trade secret, which are not owned or licensed for use by the owner or licensee of the source code 302. These examples are illustrative and do not limit the scope of the present invention. More broadly, reference source code includes any source code against which some or all of the source code 302 is intended to be compared.

The system 300 is equipped with the capability to determine or identify the granularity of analysis to be performed on the source code 302 (FIG. 4, operation 402). This granularity may, for example, be defined in terms of the number of lines of code to be analyzed in each chunk of source code. The determination of this granularity may be made through various means, including, but not limited to, receiving manual input from a human user.

The granularity of analysis influences the sensitivity and focus of the copyright or plagiarism detection process. By segmenting the source code into manageable parts, the system 300 can apply its semantic analysis more effectively, ensuring that each segment is thoroughly analyzed for potential matches with reference source code. This segmentation helps in isolating specific portions of the code, making it easier to pinpoint exact locations of potential infringements or similarities.

Configurable granularity provides the system 300 with the flexibility to adapt to various types of source code and copyright detection needs. Different projects may require different levels of scrutiny, and being able to adjust the granularity allows the system 300 to cater to a broad range of use cases, from detailed examination of small code snippets to more general analysis of large code bases. Furthermore, by adjusting the granularity, the system 300 can optimize its processing speed and resource utilization. Finer granularity might be more computationally intensive but can provide more detailed insights, whereas coarser granularity can speed up the analysis process when less detail is sufficient. This trade-off between detail and efficiency can be managed according to the user's needs. Configurable granularity also helps in balancing the breadth and depth of the analysis performed by the system 300. Finer granularity can increase the accuracy of detecting non-literal copying by focusing on smaller segments of the code, which might include subtle modifications that broader scans could overlook. This is particularly useful in complex software projects where small segments of code may carry significant intellectual property value.

The system 300 of FIG. 3 may be implemented using any of a variety of computer hardware and/or software. As merely one example, the system 300 may be implemented using a single executable software application.

The system 300 includes a chunking module 304, which receives the source code 302 as input (FIG. 4, operation 404), and chunks the source code 302 (e.g., each of a plurality of files within the source code 302) into source code chunks 306, each of which has a size that is equal to or approximately equal to the grain size previously identified (FIG. 4, operation 406). The chunking module 304 ensures that each chunk is a discrete unit of code that can be independently analyzed by the subsequent stages of the system 300, particularly for detailed semantic analysis and comparison against reference source code. In some embodiments, the chunking module 304 ensures that every chunk has exactly the previously-specified grain size, which ensures uniformity in the handling of the source code 302, and can aid in the accuracy of matching algorithms by providing a standard basis for comparison. Furthermore, by adhering to a predetermined grain size, the system 300 can optimize its computational resources. Algorithms of the system 300 can be fine-tuned to the specific chunk size, potentially improving processing speed and reducing computational overhead.

Alternatively, the chunking module 304 may allow the source code chunks 306 to vary in their grain size, which offers several advantages. For example, different sections of source code can vary significantly in complexity and functionality. By adjusting the grain size according to the complexity of different parts of the code, the system 300 can provide a more nuanced analysis. For instance, more complex functions might require finer granularity to capture subtle nuances, while simpler, more repetitive sections might be adequately analyzed with larger chunks. As another example, variable grain sizes allow the system to maintain contextual integrity by not arbitrarily cutting off code segments. This is particularly important for maintaining logical groupings of code, such as complete functions or classes, within single chunks, which can lead to more accurate semantic analysis. As yet another example, variable grain sizes can improve the detection capabilities of the system by allowing it to focus on smaller segments where exact matches might be more likely to occur, while using broader analysis for areas less likely to contain infringements. This targeted approach can increase the overall sensitivity and specificity of the detection process.

The system 300 also includes an embedding module 308, which receives some or all of the source code chunks 306 (also referred to as “grains”) as inputs (FIG. 4, operation 408), and embeds each of the grains into a format that is amenable to advanced computational analysis (FIG. 4, operation 410). For example, the embedding module 308 may embed each of some or all of the source code chunks 306 into a corresponding array (embedding) using, for example, a large language model (LLM) embedding model. This results in a plurality of semantic embeddings 310 corresponding to the plurality of source code chunks 306.

The arrays in the plurality of semantic embeddings 310 typically consist of hundreds of dimensions—commonly 768 dimensions, although this number can vary depending on the specific requirements and configurations of the system. Each dimension of the array represents a feature extracted from the source code, capturing various semantic and syntactic properties of the code.

The primary purpose of embedding source code chunks into high-dimensional arrays is to capture the underlying semantics of the code, which goes beyond mere syntactic representation. This allows the system 300 to understand more about the functionality and behavior of the code, rather than just its textual appearance. By converting the source code chunks 306 into a uniform vector format, the system 300 can easily compare different pieces of code using mathematical metrics such as cosine similarity or Euclidean distance. This is valuable for identifying similarities between the analyzed code and reference source code, even if the actual text differs significantly.

High-dimensional embeddings can be processed and compared much more efficiently than raw source code text, especially when dealing with large datasets. This scalability is vital for applications in continuous integration/continuous deployment (CI/CD) environments where rapid analysis is required. Although the plurality of semantic embeddings 310 are high-dimensional, they typically represent a reduction in dimensionality compared to the original source code when considering the complexity and length of typical software projects. This reduction helps in abstracting essential features and ignoring irrelevant details, which enhances processing speed and reduces noise in the analysis.

Although the Roberta LLM is one LLM that may be used by the embedding module 308 to generate the plurality of semantic embeddings 310, there are several alternative methods and models that can be used for embedding source code chunks. For example, besides Roberta, other LLMs like BERT, GPT, or XLNet can be employed, each offering unique strengths in terms of understanding context, handling different programming languages, or capturing long-range dependencies in code. For specific applications or proprietary programming languages, custom LLMs can be trained on domain-specific datasets to better capture the nuances and common patterns in that particular domain. Techniques such as PCA (Principal Component Analysis) or t-SNE (t-Distributed Stochastic Neighbor Embedding) can be applied after initial embedding to further reduce dimensionality and enhance the focus on features most relevant to copyright detection. By leveraging these advanced embedding techniques, the system 300 is equipped to perform robust, efficient, and accurate analysis of source code, facilitating effective detection of potential copyright infringements or unauthorized use of reference source code.

The embedding module 308 may not embed (skip over) binary chunks in the source code chunks 306. The embedding module 308 may discern text from binary data using any of a variety of techniques, such as either or both of: (1) a byte-order mark (BOM) check; and (2) by attempting to convert the bytes in the chunk into text (e.g., using a standard Python library) and determining whether the conversion completes successfully.

Selectively skipping over (not embedding) binary chunks can have a variety of benefits. For example, binary files (such as images, executables, or libraries) generally do not contain human-readable text or source code that would be meaningful to semantic analysis models like LLMs. By skipping these binary chunks, the system 300 can save substantial computational resources. This efficiency allows the system 300 to allocate more processing power and memory to analyzing text chunks where meaningful insights can be derived. Furthermore, focusing on text chunks ensures that the embeddings created are rich in relevant information and more likely to contribute to accurate analysis outcomes, such as detecting copyright infringement. As another example, binary files may include proprietary or sensitive information that might raise security or compliance issues if mishandled. By focusing on text chunks, the system 300 can potentially avoid these risks, especially if the binary content is not essential for the analysis being performed.

The system 300 may include a compression module 314, which may receive some or all of the plurality of semantic embeddings 310 as inputs (FIG. 4, operation 412) and compress those semantic embeddings to produce compressed semantic embeddings 316 (FIG. 4, operation 414). The compression module 314 may use any of a variety of compression techniques to produce the compressed semantic embeddings 316, such as binary quantization. Performing such compression may, for example, reduce the embeddings (“fingerprints”) to a relatively small size (e.g., 768 bits), which is roughly the size of a SHA 512 hash. The compression module 314 may perform compression without loss of semantic information. Any reference herein to the plurality of semantic embeddings 310 should be understood to be equally applicable to the compressed semantic embeddings 316 or to any combination of the plurality of semantic embeddings 310 and the compressed semantic embeddings 316.

The compression module 314 has a variety of advantages. For example, high-dimensional embeddings, while rich in information, can consume significant storage space. Compressing these embeddings to a smaller size drastically reduces the amount of storage needed. This is particularly advantageous in systems where large volumes of code are analyzed, leading to substantial data generation. Smaller data sizes generally translate to faster data processing. Compressed embeddings can be compared, indexed, and retrieved more quickly than their uncompressed counterparts. Despite the reduction in size, a well-designed compression algorithm, such as binary quantization, can retain the essential semantic information contained in the embeddings. This ensures that the utility of the embeddings in tasks like similarity detection or pattern recognition is not compromised.

Although binary quantization is one effective method for compressing semantic embeddings, several other techniques can also be employed depending on the specific requirements and constraints of the system such as vector quantization, dimensionality reduction, lossy compression, sparse representation, and entropy encoding. The compression module 314 may use such techniques individually or in combination in a variety of ways.

The system 300 also includes a database module 318. The system 300 provides the plurality of semantic embeddings 310 (or the compressed semantic embeddings 316), along with their metadata 312, to the database module 318, such as by transmitting such information over a network to a server that hosts the database module 318 (FIG. 4, operation 416). (Note that the embedding module 308 may extract the metadata 312 from the source code chunks 306 and/or the plurality of semantic embeddings 310.) Examples of the metadata 312 include, for each chunk, the filename of the file from which the chunk was extracted, the line number in the source file where the chunk begins, and the size of the chunk (e.g., in bytes or lines).

The database module 318 serves as a central repository for storing and managing the semantic embeddings 310, whether they are in their original form (310) or compressed form (316), along with associated metadata 312. The process of transferring the plurality of semantic embeddings 310 and metadata 312 to the database module 318 sets the stage for the subsequent analysis and retrieval processes within the system 300.

The database module 318 may, for example, be implemented using a vector database, such as pgvector. Vector databases are specialized database systems designed specifically to handle vector data, such as the plurality of semantic embeddings 310. Vector databases are optimized for storing and managing large volumes of vector data, making them ideal for the plurality of semantic embeddings 310. For example, one of the primary functions of semantic embeddings is to enable similarity searches, where the system identifies embeddings that are close or similar to each other based on their vector distances. Vector databases like pgvector are specifically designed to support these types of queries efficiently, using indexing strategies that are optimized for high-dimensional data spaces.

The database module 318 may reside on or otherwise be hosted by a server, which may be located on-premises or hosted remotely in a cloud environment. The semantic embeddings 310 and their corresponding metadata 312 may be transmitted to the database module 318 over a network, ensuring centralized storage and accessibility.

Although the database module 318 is shown and referred to herein as a “database” module, the database module 318 may more generally be implemented using any one or more data stores which are capable of performing the functions disclosed herein, whether or not such data stores take the form of a database. Furthermore, while transmitting data over a network to a server-hosted database is common, the database module 318 may be implemented locally, thereby eliminating the need for network transmission.

The system 300 includes a comparison module 322, which retrieves semantic embeddings (referred to as “retrieved embeddings 320”) stored in the database module 318 (FIG. 4, operation 418) and compares them to baseline embeddings 324 which were previously generated based on reference source code. Reference source code may include any source code which serves as a standard or benchmark for comparison, such as copyrighted source code from repositories such as GitHub or GitLab.

The comparison module 322 first retrieves the semantic embeddings (retrieved embeddings 320) from the vector database within the database module 318. These embeddings represent the semantic essence of the source code chunks analyzed by the system 300. The comparison module 322 compares the retrieved embeddings 320 to the baseline embeddings 324. The comparison may be conducted using various techniques, such as cosine similarity, although other techniques, such as L2 distance, Euclidean distance, or Manhattan distance may be used. The comparison module 322 provides the results of these comparisons in the comparison output 326, which details the similarities found between the retrieved embeddings 320 and the baseline embeddings 324 (FIG. 4, operation 420). The comparison output 326 can be used to identify potential instances of code reuse, plagiarism, or unauthorized copying.

The system 300 also includes a reporting module 328, which receives the comparison output 326 as input (FIG. 4, operation 422) and generates a comparison report 330 as output based on the comparison output 326 (FIG. 4, operation 424). The comparison report 330 may be output to a user (e.g., visually), and may take any of a variety of suitable forms to convey the contents of the comparison output 326. The comparison report 330 is intended to provide actionable insights and detailed information about the similarities detected during the comparison process. The reporting module 328 may flag any matches in the comparison output 326 that exceed a predetermined similarity threshold (e.g., a cosine similarity greater than a predetermined likeness threshold) in order to point out potential cases of copyright infringement or plagiarism to the user.

In fact, the reporting module 328 may only include output corresponding to matches in the comparison output 326 that exceed the predetermined similarity threshold in the comparison report 330, such that the comparison report 330 does not include output corresponding to matches in the comparison output 326 that do not exceed the predetermined similarity threshold. This makes it easier for the user to quickly and easily identify matches which might indicate copyright infringement or plagiarism, and which therefore merit further attention.

The comparison report 330 may, for example, incorporate interactive dashboards that allow users to explore the comparison results through visual data representations like graphs, heat maps, or network diagrams. Such user interface elements enhance user engagement and makes it easier to identify patterns and trends at a glance. The comparison report 330 may also provide options for users to generate detailed reports that delve into specific aspects of the comparison, such as particular files, modules, or time periods. The reporting module 328 may generate reports that not only cover current findings but also provide historical data comparisons to track changes and trends over time.

For an investor evaluating a potential investment in a target company, the comparison report 330 generated by system 300 offers several significant benefits. These benefits are crucial for making informed investment decisions, particularly when the quality, originality, and compliance of the software developed by the target company are key factors in the investment evaluation process. For example, the comparison report 330 can reveal how much of the target company's code is original versus how much might be derived or potentially copied from existing sources. This is crucial for assessing the value of the company's intellectual property, and enables investors to gauge the risk of intellectual property disputes or copyright infringement issues, which could affect the company's financial health and market reputation. As another example, the comparison report 330 can highlight areas where the codebase may rely heavily on outdated or problematic code, suggesting areas of potential technical debt. This can enable investors to better understand the potential costs and resources needed for future code maintenance or overhaul, which can influence the valuation of the company.

The system 300 may be used within Continuous Integration/Continuous Deployment (CI/CD) environments to enhance code compliance and integrity. CI/CD is a method of frequently integrating and deploying code changes through automated processes, which helps in maintaining software quality and accelerating the development cycle.

More specifically, the system 300 may be integrated into the CI/CD pipelines to automatically analyze code as it is committed and pushed through the development pipeline. This integration allows the system to continuously monitor and analyze new code or changes to existing code. The primary goal in this situation is to ensure that all code integrated into the product meets certain standards of compliance and originality before it is deployed. By comparing newly committed code against baseline embeddings (which include copyrighted or standard reference code), the system 300 can detect similarities that may indicate the use of copyrighted material. If the system 300 detects a high degree of similarity exceeding a predefined threshold, it can flag this for review or automatically reject the commit, preventing the potentially infringing code from being merged into the main codebase.

Such features are particularly useful in connection with automated code generation. Tools like GitHub Copilot and others assist developers by suggesting or generating code snippets based on the context provided by existing code. While these tools can significantly boost productivity, they also pose a risk of inadvertently generating code that is too similar to copyrighted material, especially since these tools learn from vast corpora of existing code, some of which may be copyrighted. By using system 300, companies can mitigate the risk of legal complications arising from the use of such tools. The system 300 can be used to ensure that any code, whether written by humans or suggested by AI tools, does not violate copyright laws before it is deployed.

To enhance the robustness and adaptability of the system 300, embodiments of the invention may incorporate the use of harmonic embeddings. Harmonic embeddings involve a method where an existing set of embeddings, generated from source code or other textual data, can be effectively adapted to a new embedding space introduced by an updated encoder model. This technique is particularly advantageous when direct access to the original data is restricted or impossible.

The process may involve using a transformation function that harmonizes the old embeddings with the new encoder, allowing them to be represented effectively in the updated vector space without the need to directly re-embed the original data. This ensures that the system can benefit from advancements in encoding technologies and improved model architectures, thereby enhancing the accuracy and relevance of the semantic comparisons, without compromising the integrity or availability of the original embeddings.

Harmonic embeddings are especially relevant in maintaining the continuity and consistency of the system 300's operations when transitioning between different embedding models. This capability ensures that the system 300 remains up-to-date with the latest technological advancements in natural language processing and machine learning, while still preserving the utility and value of previously generated data.

Embodiments of the present invention create, store, and compare embeddings rather than directly comparing source code. This approach not only enhances the efficiency and effectiveness of detecting copyright infringement and plagiarism, but also crucially respects the sensitive and confidential nature of the source code being analyzed. More specifically, embodiments of the invention may transform source code into high-dimensional vector embeddings using, for example, a language model (e.g., a large language model, a small language model) or other artificial neural network. These embeddings capture the semantic essence of the code without retaining its exact textual form. By converting source code into abstract embeddings, the actual content of the source code is not exposed or stored directly. This abstraction layer helps protect the confidentiality of the source code. Similarly, since embeddings are high-level representations and do not contain direct code snippets, they inherently reduce the risk of sensitive code leakage.

Preserving the confidentiality of source code can be particularly valuable during the due diligence process, such as when an investor is evaluating a company that has developed proprietary software. This approach not only protects the intellectual property of the company being assessed but also ensures that the due diligence process itself adheres to high standards of data security and ethical business practices. By maintaining the confidentiality of the source code, the due diligence process protects the target company's intellectual assets from potential leaks or unauthorized access. This is crucial for software that includes innovative algorithms, business logic, or that serves as a competitive advantage. Due diligence often involves NDAs to protect sensitive information. Preserving the confidentiality of source code ensures compliance with these legal agreements, reducing the risk of legal repercussions. Investors can use embodiments of the invention to gain a deeper understanding of the technological value and potential risks associated with the target company's software assets without compromising the security or proprietary nature of the code. This informed perspective supports better strategic decision-making regarding the investment.

Because embodiments of the invention compare embeddings to each other (e.g., the retrieved embeddings 320 and the baseline embeddings 324), such comparisons may detect non-literal copying of source code. This feature is particularly valuable in contexts such as due diligence performed by an investor on a target software development company, where understanding the uniqueness and integrity of the software code is crucial. As previously described, embodiments of the may transform source code into high-dimensional vector embeddings that capture the semantic essence of the code. This transformation abstracts the code's meaning from its literal representation. Because the embeddings represent semantic content, modifications to the code that do not change its meaning (such as renaming variables, changing whitespace, or altering comments and formatting) do not significantly alter the embeddings. This allows embodiments of the invention to recognize the underlying semantic similarities despite superficial changes.

In comparison, traditional methods of code comparison often rely on textual analysis, which can miss instances where the code has been altered superficially but still retains the original's functionality or intent. By focusing on semantic similarities, embodiments of the invention can detect cases of non-literal copying—where the code's structure or syntax might have been changed but the functional essence remains the same. This includes scenarios where code has been refactored, optimized, or translated into another programming language but still performs the same operations.

As a result, investors can use embodiments of the present invention to perform a more comprehensive analysis of the target company's codebase, ensuring that not only direct copies but also subtly altered copies are identified. This thoroughness is crucial for assessing the true originality and value of the software assets. Detecting non-literal copying helps ensure that the software does not infringe on existing copyrights, which is a significant legal risk in software development. This is particularly important when the software uses open-source components that might have strict licensing conditions. By identifying potential issues of non-literal copying, investors can better manage the risks associated with intellectual property disputes, which can be costly and damaging to the company's reputation. In summary, the ability of embodiments of the invention to compare semantic embeddings rather than direct code text allows for a nuanced, in-depth analysis of code originality and integrity. This capability is particularly valuable during due diligence processes, where investors need to ascertain the legal standing, compliance, and intrinsic value of the software developed by a target company.

One advantage of embodiments of the present invention is that they store data (e.g., the plurality of semantic embeddings 310 and the baseline embeddings 324) in a highly space-efficient manner. For example, the system 300 may apply compression techniques, thereby reducing each embedding to a more manageable size, such as 768 bits, roughly the size of a SHA-512 hash. This compression significantly reduces the storage footprint without losing critical semantic information. As another example, the system 300 may utilize specialized vector databases (e.g., pgvector) that are optimized for storing and querying high-dimensional data efficiently. These databases can handle the storage and retrieval of compressed embeddings effectively, enhancing both space efficiency and query performance. By compressing the embeddings and reducing their size, the system 300 not only minimizes the amount of storage required, but can also improve the speed of data access and retrieval. Compressed embeddings can be processed, compared, and indexed more quickly, enhancing the overall performance of the system 300. Testing has demonstrated that embodiments of the invention can be 10,000 more space-efficient than competing algorithms.

Embodiments of the present invention may use indexed, semantic vectors to significantly enhance the efficiency and accuracy of searching and comparing source code. As described above, the plurality of semantic embeddings 310 created from the source code 302 may be stored in a vector database that uses indexing techniques optimized for high-dimensional data. Indexing these vectors allows for rapid retrieval and comparison, significantly speeding up the search process compared to non-indexed data. Furthermore, indexed searches scale efficiently with the size of the dataset. As more source code is added and more embeddings are created, the system 300 can maintain its performance due to the efficient indexing strategies.

Furthermore, because the vectors represent the semantic meaning of the source code 302 rather than its literal text, changes to the source code 302 that do not affect its functionality, such as renaming variables, modifying whitespace (in languages where whitespace is not syntactically significant), or changing comments, do not alter the semantic vectors significantly. This allows the system 300 to recognize code that performs the same function but is written differently. In languages like Python, where whitespace is significant to the structure of the code, the system 300's semantic analysis is designed to consider these aspects when creating embeddings. This ensures that the embeddings accurately reflect the code's meaning, even in languages with unique syntactic rules.

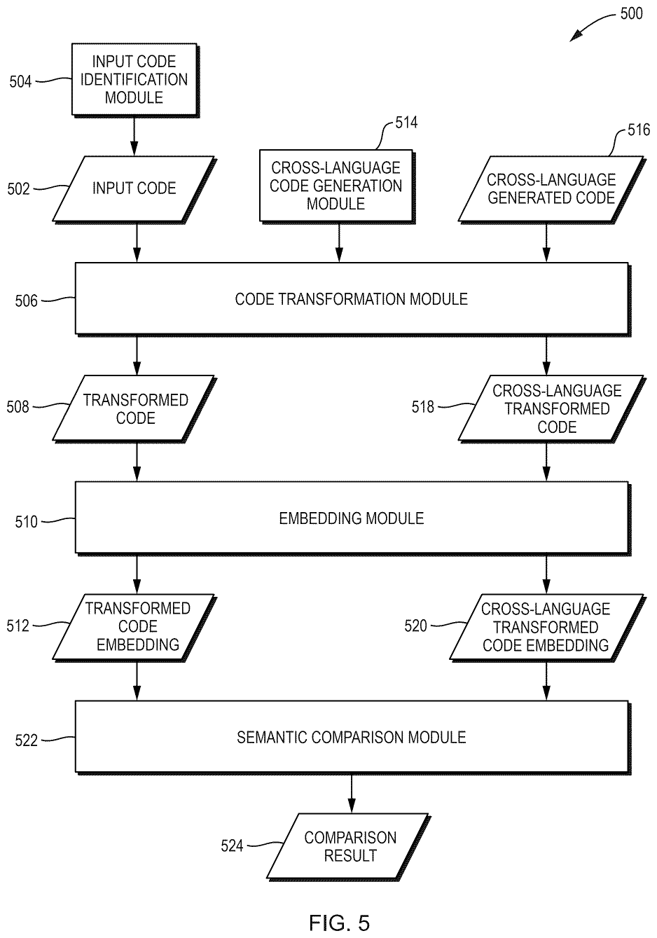

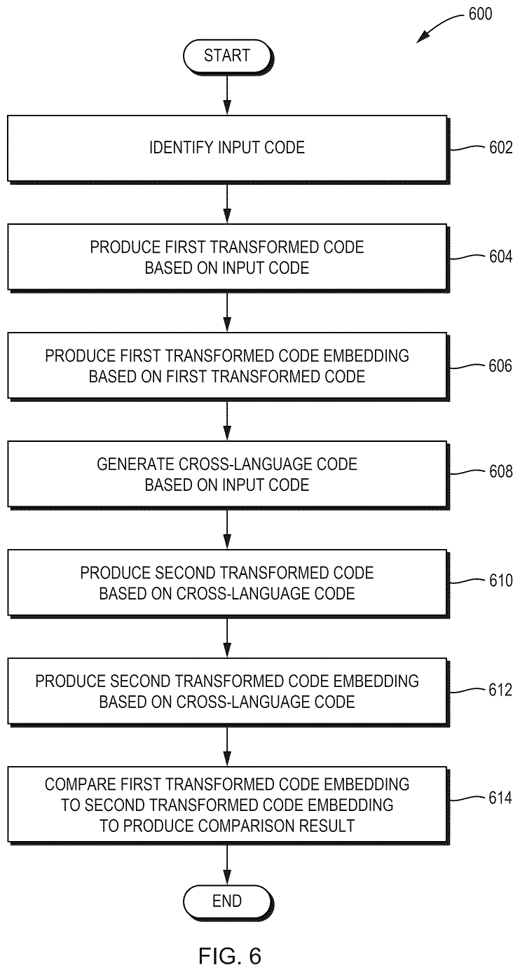

Referring to FIG. 5, a dataflow diagram is shown of a system 500 for performing cross-language malicious code detection according to one embodiment of the present invention. Referring to FIG. 6, a flowchart is shown of a method 600 that is performed by the system 500 of FIG. 5 according to one embodiment of the present invention.

The system 500 includes an input code identification module 504, which receives or otherwise generates or identifies input code 502 (FIG. 6, operation 602). The input code 502 serves as the starting point for the cross-language malicious code detection process performed by embodiments of the present invention. The input code 502 may be written in any programming language or combination of programming languages.

The input code identification module 504 may identify the input code 502 through various automated and/or user-directed methods, depending on the specific implementation and deployment context of the system 500. These identification methods may be designed to accommodate different operational environments and integration requirements.

In automated scenarios, the input code identification module 504 may, for example, continuously monitor file systems for new and/or modified source code files. For example, the module 504 may use file system watchers or polling mechanisms to detect changes in designated directories containing source code repositories. When new files are added or existing files are modified, the input code identification module 504 may automatically identify these files as input code 502 for analysis. This approach may be particularly useful in development environments where code is frequently updated.

The input code identification module 504 may integrate with version control systems such as Git, Subversion, or Mercurial to identify input code 502. In such implementations, the module 504 may monitor commit hooks, pull requests, or merge events to automatically capture code changes as they occur in the development workflow. This integration allows the system 500 to analyze code at various stages of the development process, from initial commits to production deployments.

The input code identification module 504 may receive input code 502 through one or more application programming interfaces (APIs). These APIs may be designed to accept code submissions from external systems, continuous integration/continuous deployment (CI/CD) pipelines, and/or integrated development environments (IDEs). For example, a REST API endpoint may allow other systems to submit source code files or code snippets for analysis by posting the code content along with metadata such as programming language, file paths, and/or project identifiers.

The input code identification module 504 may identify input code 502 through direct user interaction. Users may upload source code files through a web interface, desktop application, and/or command-line tool. In such cases, the module 504 may provide file selection dialogs, drag-and-drop functionality, and/or batch upload capabilities to facilitate the submission of single files or entire code repositories. The module 504 may support various file formats and may automatically extract code from compressed archives such as ZIP and/or TAR files.

In enterprise environments, the input code identification module 504 may integrate with code scanning tools, security scanners, and/or compliance systems that have already identified potentially suspicious or problematic code. These systems may flag specific code segments or files, which are then automatically forwarded to the input code identification module 504 for further analysis using the cross-language malicious code detection capabilities of the system 500.

The input code identification module 504 may identify input code 502 from network traffic analysis and/or runtime monitoring systems. For example, the module 504 may receive code samples that have been extracted from network packets, memory dumps, and/or execution traces by security monitoring tools. This capability may be particularly valuable for analyzing code that is dynamically loaded, injected, and/or transmitted over networks.

The input code identification module 504 may implement scheduled scanning operations where it periodically examines predefined code repositories, directories, and/or databases to identify new or modified source code that requires analysis. These scheduled operations may be configured with specific intervals, such as hourly, daily, and/or weekly scans, depending on the organization's security and compliance requirements.

The module 504 may support real-time streaming of code data, where input code 502 is continuously received from live development environments, build systems, and/or deployment pipelines. This streaming approach allows the system 500 to provide immediate feedback on potential security issues as code is being written or deployed, enabling rapid response to detected threats.

The input code 502 may take any of a variety of forms. For example, it may be suspicious code that requires analysis for potential malicious content or behavior. Such suspicious code may take any form, be of any language, and be written in any programing language or combination of programming languages. Some examples of the forms that the input code 502 may take include any one or more of the following.

The input code 502 may include code that implements code obfuscation and/or evasion techniques, such as any one or more of the following:
Obfuscated code: This may be intentionally obscured or convoluted code designed to hide its true functionality, making it difficult for traditional analysis tools to detect its malicious nature.
Encrypted malware: Code segments that appear as seemingly random data but decrypt to malicious instructions at runtime.
Polymorphic code: Malicious code that can mutate its appearance while maintaining its underlying functionality, often used to evade signature-based detection methods.
Anti-analysis code: Malicious code that detects and evades debugging, sandboxing, or reverse engineering attempts.

The input code 502 may include code that uses system access/privilege exploitation, such as any one or more of the following:
Backdoors or remote access tools: Suspicious code that could provide unauthorized access to systems or data.
Rootkits or bootkit code: Low-level malicious code designed to gain privileged access to systems.
Privilege escalation exploits: Code designed to gain higher-level system permissions than originally granted.
Process injection techniques: Malicious code that injects itself into legitimate running processes to avoid detection.

The input code 502 may include code that implements vulnerability exploitation and/or attack vectors, such as any one or more of the following:
Injection attacks: Code snippets designed to exploit vulnerabilities in input validation, such as SQL injection or cross-site scripting (XSS) attacks.
Code exploiting zero-day vulnerabilities: Malicious code targeting previously unknown security flaws in software or systems.
Supply chain attacks: Malicious code embedded in legitimate software dependencies or build processes.
Living-off-the-land techniques: Code that leverages legitimate system tools and utilities for malicious purposes.

The input code 502 may include code that implements data theft and/or network communication, such as any one or more of the following:
Command and control (C&C) communication code: Code that establishes covert channels to receive instructions from remote attackers.
Data exfiltration code: Malicious code designed to steal and transmit sensitive information to external servers.
Network scanning and reconnaissance code: Code that probes network infrastructure to identify vulnerabilities or gather intelligence.

The input code 502 may include code that implements system persistance and/or manipulation, such as any one or more of the following:
Persistence mechanisms: Code that ensures malware survives system reboots and maintains long-term access.
Registry manipulation code: Code that modifies system registry entries to maintain persistence or alter system behavior.
Fileless malware: Malicious code that operates primarily in memory without writing files to disk, making it harder to detect through traditional means.

The input code 502 may include code that implements embedded and/or document-based threats, such as malicious scripts and/or macros.

The input code 502 may include code that implements cross-platform and/or multi-language threats, such as multi-language malware. This may include suspicious code that spans multiple programming languages, potentially leveraging language-specific features to evade detection.

The input code 502 may include code that implements social engineering and/or deception-based attacks, such as any one or more of the following:
Phishing kit components: Code designed to create convincing fake login pages or credential harvesting mechanisms.
Scareware or fake antivirus code: Malicious code that displays false security warnings to trick users into taking harmful actions.

The input code 502 may include code that implements resource exploitation, such as cryptocurrency mining malware. Such code may hijack system resources to mine digital currencies without authorization.

The input code 502 may be or describe an example of a language antipattern-a programming practice that is considered inefficient, problematic, or potentially harmful. Language antipatterns are common but ineffective or counterproductive programming practices that can lead to code that is difficult to maintain, prone to errors, and potentially insecure. The input code 502 may represent any of various such antipatterns, including: god objects (a class that tries to do too much, violating the single responsibility principle); magic numbers (the use of unexplained numeric literals in code, making it difficult for others to understand the significance of these values); spaghetti code (code with a complex and tangled control structure, often due to excessive use of GOTO statements or lack of proper structuring); hardcoding (embedding configuration data directly into the source code instead of storing it in external configuration files); memory leaks (failure to properly deallocate memory, leading to gradual loss of available memory over time); and null pointer dereferences (attempting to use a null reference, which can cause crashes or unexpected behavior).

The input code 502 may include one or more blocks of suspicious code, one or more antipatterns, and any combination thereof. For instance, the input code 502 may contain a segment of obfuscated code that appears suspicious, alongside an implementation of a “God Object” antipattern. As another example, the input code 502 may include a potential SQL injection vulnerability combined with an instance of the “hardcoding” antipattern.

The input code 502 may, for example, have been identified by the source code plagiarism detection techniques illustrated and described above in connection with FIGS. 1-4. For instance, the input code 502 may have been flagged as potentially plagiarized or suspicious based on semantic similarity comparisons performed by the system 300 (FIG. 3) and method 400 (FIG. 4). However, it is important to note that the input code 502 need not have been identified by embodiments of the source code plagiarism invention disclosed herein. More generally, the input code 502 may be identified in any of a variety of ways.

In some embodiments, the input code 502 may include or consist of text that is written in a natural language (e.g., English) rather than a programming language. For example, the input code 502 may include both text written in a programming language and text written in a natural language. Such natural language text may include vulnerability descriptions, security advisories, threat intelligence reports, and/or documentation that describes malicious behaviors or attack patterns. The input code 502 may, for example, include natural language descriptions from sources such as the National Vulnerability Database (NVD), MITRE ATT&CK framework entries, security bulletins, and/or threat research publications. In some cases, the natural language text in the input code 502 may describe specific attack techniques, malware behaviors, or security vulnerabilities that may be compared against actual code implementations to identify potential matches or similarities. The system 500 may process such natural language input using the same analytical framework as programming language code, enabling cross-domain analysis between textual threat descriptions and actual code implementations. The term “input text,” as used herein, refers to any kind of text (e.g., text written in a natural language and/or text written in a programming language), unless otherwise specified.

The system 500 includes a code transformation module 506, which receives the input code 502 as input and transforms the input code 502 to produce transformed code 508 (also referred to herein as “first transformed code” or the “transformed input code”) as output (FIG. 6, operation 604). Although the transformed code 508 may take any of a variety of forms, in certain embodiments it may be a higher-level, more abstract representation of the input code 502. As will be described in more detail below, this transformation process may enable the system 500 to analyze code from various programming languages using a unified approach, enhancing its cross-language capabilities.

The code transformation module 506 may operate by parsing the input code 502 and generating an intermediate representation that captures the essential structure and semantics of the original code. This transformed code 508 may be represented and stored in various formats, such as WASM (WebAssembly), which may serve as a low-level binary instruction format and portable compilation target, LLVM IR (Intermediate Representation), which may function as a low-level virtual machine language, Java bytecode, .NET Common Intermediate Language (CIL), Abstract Syntax Trees (ASTs), and/or any combination thereof, depending on the specific implementation and requirements of the system 500.

The intermediate representation may include additional features that enhance the system's analytical capabilities across different embodiments. For example, the intermediate representation may preserve control flow information, including branching patterns, loop structures, and/or function call hierarchies, which may facilitate detection of malicious control flow patterns that could indicate obfuscated or evasive code.

The intermediate representation may maintain data flow information that tracks how data moves through the code, including variable assignments, parameter passing, and/or return values, which may enable the system to identify suspicious data manipulation patterns or unauthorized data access attempts across different programming languages. The intermediate representation may incorporate type information from the original source code, including primitive types, object types, and/or custom data structures, which may allow the system to detect type confusion attacks or improper type casting that could indicate malicious intent.

The intermediate representation may include memory access patterns and memory management operations, such as allocation, deallocation, and/or pointer arithmetic, which may help identify buffer overflow attempts, use-after-free vulnerabilities, or other memory-based attack vectors. The intermediate representation may preserve function signatures and calling conventions, including parameter types, return types, and/or calling mechanisms, which may enable cross-language analysis of function behavior and identification of suspicious function calls or parameter manipulation.

Furthermore, the intermediate representation may maintain dependency information that shows relationships between different code components, modules, and/or libraries, which may facilitate identification of malicious code that attempts to exploit or manipulate external dependencies. The intermediate representation may include annotation or metadata fields that can store additional semantic information about the code, such as security-relevant attributes, performance characteristics, and/or behavioral indicators, which may provide additional context for malicious code detection algorithms.

The intermediate representation may support hierarchical structuring that preserves the original code's organizational structure, including namespaces, classes, and/or modules, which may enable analysis at different levels of granularity and help identify structural anomalies that could indicate malicious modifications. Additionally, the intermediate representation may incorporate exception handling information, including try-catch blocks, error propagation paths, and/or exception types, which may help identify code that attempts to suppress or manipulate error conditions in suspicious ways.

The intermediate representation may include timing and execution order information that captures the intended sequence of operations and/or potential concurrency patterns, which may enable detection of race conditions, timing attacks, and/or other execution-order-dependent malicious behaviors.

The system 500 also includes an embedding module 510, which receives the transformed code 508 as input and creates an embedding, referred to herein as the transformed code embedding 512 (also referred to herein as the “first transformed code embedding” or the “transformed input code embedding”), based on the transformed code 508 (FIG. 6, operation 606). The purpose of the embedding module 510 is to convert the transformed code 508 into a vector representation (e.g., a high-dimensional vector representation) that captures the semantic essence of the transformed code 508, enabling more efficient and effective analysis for malicious patterns or antipatterns.

The transformed code embedding 512 may serve as a compact and meaningful representation of the original input code 502, now in a format that may be amenable to advanced computational analysis. As will be described in more detail below, the transformed code embedding 512 may enable the system 500 to perform sophisticated comparisons and detect similarities or anomalies that might indicate the presence of malicious code or problematic programming practices across different programming languages.

The two-step process of first transforming the input code 502 into the transformed code 508 and then generating the transformed code embedding 512 may provide several advantages for cross-language malicious code detection.

For example,, the code transformation module 506 may normalize code from different programming languages into a common intermediate representation before the embedding module 510 generates embeddings. For instance, code written in Python, JavaScript, C++, or Java may all be transformed into a standardized format like WASM or LLVM IR. This unified foundation may enable more consistent semantic analysis across languages compared to directly embedding language-specific syntax.

During transformation, the system 500 may abstract away language-specific implementation details while preserving essential behavioral characteristics. While different programming languages may use varying syntax for loops, conditionals, and function calls, their underlying control flow patterns often remain semantically equivalent. By focusing on these essential patterns in the transformed code 508, the system 500 may better identify malicious intent across programming languages.

The intermediate representation may enable the embedding module 510 to generate consistent embeddings across different programming languages. For example, a buffer overflow vulnerability implemented in C and the same vulnerability pattern implemented in C++ may produce similar transformed code 508 representations, resulting in comparable transformed code embeddings 512.

The transformation step may also enhance handling of obfuscated and polymorphic code. By converting input code 502 into a standardized intermediate representation, the code transformation module 506 may strip away obfuscation techniques, revealing the underlying semantic structure that the embedding module 510 captures in the transformed code embedding 512.

The intermediate representation may facilitate extraction of security-relevant features in a standardized format. The transformed code 508 may preserve control flow information, data flow patterns, memory access patterns, and function call hierarchies, allowing the embedding module 510 to generate embeddings that consistently capture these features across programming languages.

This approach may improve scalability by enabling the system 500 to use a single embedding model that operates on the standardized intermediate representation, rather than requiring separate models for each programming language. This approach may reduce system complexity and enable more efficient training and updating of embedding models.

Additionally, the transformation step may allow the system 500 to leverage existing compiler and analysis infrastructure. Intermediate representations like LLVM IR and WASM may have established toolchains and analysis frameworks that the code transformation module 506 may utilize, providing access to sophisticated code analysis capabilities.

The embedding module 510 may generate the transformed code embedding 512 using any of a variety of techniques, such as any one or more of the following:
Large Language Models (LLMs): Similar to the approach used in the source code plagiarism detection system 300, an LLM may be employed to generate embeddings that capture the semantic meaning of the transformed code 508.
Specialized Code Embedding Models: Models specifically trained on code repositories to understand programming language structures and patterns.
Graph Neural Networks: If the transformed code 508 is represented as a graph (e.g., Abstract Syntax Tree), graph-based embedding techniques may be used.
Transformer-based Models: Architectures like BERT or CodeBERT, adapted for code understanding, may be used to generate contextual embeddings of code snippets.
Convolutional Neural Networks (CNNs): CNNs may be adapted for code analysis by treating code as sequential data or by applying convolution operations to token sequences, which may be particularly effective for identifying local patterns and code structures.
Recurrent Neural Networks (RNNs) and Long Short-Term Memory (LSTM) Networks: These architectures may be used to capture sequential dependencies in code, making them suitable for understanding the flow and context of programming constructs over longer code sequences.
Autoencoders: Variational autoencoders or standard autoencoders may be employed to learn compressed representations of the transformed code 508, potentially capturing essential features while reducing dimensionality.
Word2Vec and FastText Adaptations: Traditional word embedding techniques may be adapted for code tokens, treating programming language keywords, identifiers, and operators as vocabulary elements to generate embeddings.
Hybrid Embedding Approaches: Combinations of multiple embedding techniques may be used, such as concatenating or averaging embeddings from different models to capture diverse aspects of the code semantics.
Static Analysis-Based Embeddings: Embeddings may be generated based on static analysis features such as control flow graphs, data dependency graphs, or call graphs, which may provide structural insights into the code behavior.
Frequency-Based Embeddings: Techniques such as TF-IDF (Term Frequency-Inverse Document Frequency) may be adapted for code analysis, where code tokens are treated as terms and code files as documents.
Metric Learning Approaches: Specialized neural networks may be trained to learn embeddings that optimize specific distance metrics relevant to code similarity and malicious pattern detection.

The transformed code embedding 512 may be implemented in any of a variety of ways, such as any one or more of the following:
High-dimensional arrays (e.g., 512, 768, 1024, 1536, 2048, or 4096 dimensions) representing the semantic features of the transformed code 508.
Dense Vectors: High-dimensional vector representations where most or all dimensions contain non-zero values, providing rich semantic information but requiring more storage and computational resources compared to sparse representations.
Sparse Representations: Embeddings that capture specific code features in a high-dimensional, but sparse format.
Hierarchical Embeddings: Representations that capture both local (e.g., function-level) and global (e.g., file-level) characteristics of the transformed code 508.
Multi-modal Embeddings: Combinations of different embedding types to capture various aspects of the transformed code 508, such as syntax, semantics, and data flow.
Graph-based Embeddings: Vector representations derived from graph structures such as Abstract Syntax Trees (ASTs), control flow graphs, or data dependency graphs, where nodes and edges are embedded to capture structural relationships in the code.
Contextual Embeddings: Dynamic representations that change based on the surrounding code context, similar to how words in natural language have different meanings in different contexts.
Attention-based Embeddings: Representations that incorporate attention mechanisms to focus on the most relevant parts of the transformed code 508 when generating the embedding.
Compressed or Quantized Embeddings: Reduced-precision representations that maintain semantic information while significantly reducing memory footprint, such as binary quantization or low-precision floating-point formats.
Ensemble Embeddings: Combinations of multiple embedding techniques averaged, concatenated, or otherwise merged to leverage the strengths of different approaches.
Token-level vs. Sequence-level Embeddings: Distinctions between embeddings that represent individual code tokens versus embeddings that represent entire code sequences or functions.
Learned vs. Fixed Embeddings: Representations that are either learned during training or based on predefined features extracted from static analysis.
Temporal Embeddings: Representations that capture the execution order or temporal aspects of code behavior, particularly relevant for dynamic analysis scenarios.

By utilizing these advanced embedding techniques, the embedding module 510 enables the malicious code detection system 500 to perform nuanced analysis on code from diverse programming languages, enhancing its ability to identify potential security threats and antipatterns.

The system 500 also includes a cross-language code generation module 514, which receives the input code 502 as input, and generates code, referred to herein as cross-language generated code 516 (FIG. 6, operation 608).

The cross-language generated code 516 represents a transformation of the input code 502. For example, the input code 502 may be written (in whole or in part) in a first programming language, and the cross-language generated code 516 may be written (in whole or in part) in a second programming language that differs from the first programming language. Representative examples of first programming language and second programming language pairs may include, for example, Python to JavaScript, Java to C++, C to Python, JavaScript to Java, C++ to C, Python to C++, Java to Python, C to JavaScript, JavaScript to C++, and/or C++ to Python. As another example, the first programming language may be a high-level language such as Python and/or Java, while the second programming language may be a lower-level language such as C and/or C++. Alternatively, the first programming language may be a compiled language such as C++ and/or Java, while the second programming language may be an interpreted language such as Python and/or JavaScript. This process enables the system 500 to analyze potential security threats and antipatterns across multiple programming languages, enhancing its versatility and effectiveness.

The cross-language code generation module 514 may generate the cross-language generated code 516 based on the input code 502 using any of a variety of techniques, such as any one or more of the following:
Variational Autoencoder (VAE): A VAE may be used to encode the input code 502 into a latent space representation and then decode it into a different target language in the cross-language generated code 516. This approach allows for capturing the semantic meaning of the input code 502, while generating structurally different but functionally equivalent code in another language.
Neural Machine Translation (NMT) Models: Similar to language translation, NMT models may be adapted to translate code from one programming language to another. These models can learn the mapping between source and target language syntax and semantics.
Abstract Syntax Tree (AST) Manipulation: The input code 502 may be parsed into an AST, which may then be transformed and regenerated in the target language of the cross-language generated code 516. This method preserves the structural and semantic information of the input code 502 across languages.
Rule-Based Transformation Systems: A set of predefined rules may be used to map constructs from the source language of the input code 502 into equivalent constructs in the target language of the cross-language generated code 516. This approach is particularly useful for handling language-specific idioms and patterns.
Hybrid Approaches: Combinations of two or more of the above methods may be employed to leverage the strengths of different techniques. For example, both rule-based transformations and neural models may be used to handle different aspects of the translation process.

These diverse approaches allow the cross-language code generation module 514 to handle a wide range of programming languages and code structures, enhancing the system's ability to detect malicious patterns and antipatterns across different language paradigms.

As previously described, the system 500 includes the code transformation module 506, which received the input code 502 as input and transformed the input code 502 to produce the transformed code 508 as output. Similarly, the system 500 may use the code transformation module 506 to receive the cross-language generated code 516 as input, and to transform the cross-language generated code 516 to produce cross-language transformed code 518, in any of the ways previously described in connection with transforming the input code 502 to generate the transformed code 508 (FIG. 6, operation 610). The cross-platform transformed code 518 may, for example, take any of the forms disclosed herein in connection with the transformed code 508.

The code transformation module 506 may, for example, use the same techniques to transform the input code 502 into the transformed code 508 as the code transformation module 506 uses to transform the cross-language generated code 516 into the cross-language transformed code 518. As a particular example, the code transformation module 506 may transform the input code 502 into WASM in the transformed code 508 and transform the cross-language generated code 516 into WASM in the cross-language transformed code 518.

By transforming both the original input code 502 and the cross-language generated code 516 using the same module and techniques, the system 500 may ensure a uniform approach to code analysis across multiple languages. This consistency provides several significant advantages for cross-language malicious code detection.

First, using identical transformation techniques creates a standardized foundation for comparison, ensuring that any differences detected between the transformed code embedding 512 and the cross-language transformed code embedding 520 reflect genuine semantic variations rather than artifacts introduced by different transformation methodologies. Second, this uniform approach enables more reliable detection of malicious patterns and antipatterns by eliminating transformation-related noise that could mask or falsely indicate security threats. Third, the consistency facilitates more accurate semantic comparisons between the input code 502 and its cross-language counterpart (i.e., the cross-language generated code 516), as both code variants are processed through identical analytical pipelines.

Fourth, this approach enhances the system's ability to identify subtle obfuscation techniques or malicious modifications that might be obscured when using disparate transformation methods. Finally, the uniform transformation methodology improves the scalability and maintainability of the system 500 by reducing the complexity of managing multiple transformation approaches and ensuring consistent behavior across different programming language pairs.

In some embodiments, the system 500 may employ different transformation techniques to transform the cross-language generated code 516 into the cross-language transformed code 518 than those used to transform the input code 502 into the transformed code 508. For example, the code transformation module 506 may apply a first transformation technique (such as WASM compilation) to the input code 502, while applying a second, different transformation technique (such as LLVM IR generation) to the cross-language generated code 516. The system 500 may include a separate code transformation module (not shown) that operates independently from the code transformation module 506 and uses distinct transformation approaches for processing the cross-language generated code 516.

These embodiments may provide several advantages for cross-language malicious code detection. For example, using different transformation techniques may enable the system 500 to capture complementary aspects of code behavior and structure that might not be apparent when using identical transformation approaches. The input code 502 and cross-language generated code 516 may have different characteristics due to their respective programming languages, and applying language-optimized transformation techniques may better preserve the semantic essence of each code variant.

Additionally, different transformation techniques may enhance the system 500's ability to detect subtle variations in malicious patterns that could be masked when using uniform transformation approaches. For instance, certain obfuscation techniques or malicious code patterns may be more readily apparent in one intermediate representation format than another. By generating diverse transformed representations, the system 500 may increase its sensitivity to a broader range of potential security threats.

Furthermore, employing varied transformation techniques may improve the robustness of the semantic comparison performed by the semantic comparison module 522. When the transformed code embedding 512 and cross-language transformed code embedding 520 are derived from different intermediate representations, their comparison may reveal inconsistencies or anomalies that indicate the presence of malicious modifications or injected code that might otherwise remain undetected in a uniform transformation approach.

In other embodiments, the system 500 may employ ensemble transformation techniques that combine both uniform and diverse transformation approaches. These ensemble methods may apply multiple transformation techniques to both the input code 502 and the cross-language generated code 516, generating multiple intermediate representations for each code variant. For example, the system 500 may simultaneously transform the input code 502 into both WASM and LLVM IR formats, while also transforming the cross-language generated code 516 into the same multiple formats.

The ensemble transformation approach may leverage the advantages of both uniform and diverse transformation methodologies. By generating multiple transformed representations using the same techniques for both code variants, the system 500 may maintain the consistency benefits of uniform transformation while also capturing the complementary insights provided by different intermediate representation formats. This multi-faceted approach may enhance the system 500's ability to detect malicious patterns by providing a more comprehensive view of the code's semantic structure and behavior.

The ensemble transformation techniques may be implemented using weighted combinations of different transformation outputs, where each transformation method contributes to the final analysis based on its effectiveness for specific types of code patterns or security threats. Alternatively, the system 500 may employ parallel processing of multiple transformation techniques, allowing for simultaneous analysis across different intermediate representations to improve both accuracy and processing efficiency.

As previously described, the system 500 includes the embedding module 510, which receives the transformed code 508 as input and creates the transformed code embedding 512 based on the transformed code 508. Similarly, the embedding module 510 may receive the cross-language transformed code 518 as input, and embed the cross-language transformed code 518 to produce a cross-language transformed code embedding 520, in any of the ways previously described in connection with embedding the transformed code 508 to produce the transformed code embedding 512 (FIG. 6, operation 612). This process allows the system 500 to generate consistent embeddings for both the original input code 512 and the cross-language generated code 516, facilitating more effective comparison and analysis across different programming languages.

For example, the embedding module 510 may use the same techniques to generate the transformed code embedding 512 based on the transformed code 508 and to generate the cross-language transformed code embedding 520 based on the cross-language transformed code 518. By applying the same embedding techniques to both the original transformed code 508 and the cross-language transformed code 518, the system 500 ensures a uniform approach to code representation across multiple languages. This consistency enhances the system 500's ability to detect malicious patterns and antipatterns, and facilitates comparisons between the original input code 502 and its cross-language counterpart 516.

In some embodiments, the system 500 may employ different embedding techniques for generating the transformed code embedding 512 and the cross-language transformed code embedding 520, depending on the specific implementation and objectives of the system 500. This approach may provide several advantages for cross-language malicious code detection while addressing the unique characteristics of different programming languages and intermediate representations.

Different embedding techniques may be optimized for specific programming languages or intermediate representations. For example, the embedding module 510 may use Python-trained models for the transformed code 508 and C++-trained models for the cross-language transformed code 518, capturing language-specific semantic nuances more effectively than uniform approaches. Using different embedding techniques may improve anomaly detection by revealing transformation artifacts or malicious modifications through discrepancies in vector representations. This enhanced capability may be particularly valuable for identifying sophisticated attacks that exploit the cross-language transformation process.

Different embedding techniques may capture complementary semantic aspects, such as one technique excelling at control flow patterns while another represents data flow relationships. This diversity may provide the semantic comparison module 522 with richer features for more accurate malicious code detection. Using different embedding techniques may provide robustness against adversarial attacks. While malicious actors might craft code to evade single embedding approaches, diverse techniques create multiple analysis layers that adversarial code must simultaneously circumvent.

Different embedding techniques may serve as independent validation mechanisms. Similar semantic representations from different approaches may provide higher confidence in transformation quality, while significant differences may indicate transformation issues or malicious modifications.

The transformed code 508 and cross-language transformed code 518 may benefit from different neural network architectures or model configurations. For example, the embedding module 510 may use transformer-based embeddings for the original transformed code 508, while employing graph neural network approaches for the cross-language transformed code 518 if it has been transformed into a graph-based intermediate representation. This specialization may allow each embedding technique to leverage the most appropriate architectural approach for its specific input format.

The embedding module 510 may implement these different embedding techniques using various combinations of approaches. For example, the module 510 may use convolutional neural networks for analyzing sequential patterns in one code variant while employing recurrent neural networks for capturing temporal dependencies in another. Alternatively, the embedding module 510 may combine static analysis-based embeddings for one code variant with frequency-based embeddings for another, depending on the characteristics of the respective intermediate representations.

The system 500 also includes a semantic comparison module 522, which receives the transformed code embedding 512 and the cross-language transformed code embedding 520 as inputs and produces a comparison result 524 as an output (FIG. 6, operation 614). The comparison result 524 may represent the results of the semantic comparison between the embeddings, providing data that may be used to evaluate the relationship between the original input code 502 and the cross-language generated code 516. The semantic comparison module 522 may be responsible for evaluating the semantic similarity between the original input code 502 and the cross-language generated code 516 by comparing their respective embeddings 512 and 520.

For example, the loss function of a Variational Autoencoder (VAE) used by the cross-language code generation module 514 may be defined as the semantic distance between the transformed code embedding 512 and the cross-language transformed code embedding 520. This loss function serves as a measure of how well the cross-language code generation process preserves the semantic meaning of the original input code 502 when translating it into a different programming language in the cross-language generated code 516.

By using this semantic distance as the loss function, the system 500 aims to minimize the difference between the original input code 102's embedding and the embedding of the cross-language generated code cross-language generated code 516. This approach encourages the VAE to generate code in the target language that maintains the essential semantic characteristics and functionality of the original input code 502.

The semantic comparison module 522 may compare the transformed code embedding 512 to the cross-language transformed code embedding 520 using any of a variety of techniques, such as any one or more of the following:
Cosine Similarity: This method calculates the cosine of the angle between the two embedding vectors. It's particularly useful for high-dimensional spaces and provides a measure of orientation similarity.
Euclidean Distance: This approach measures the straight-line distance between the two embedding vectors in the high-dimensional space. A smaller distance indicates greater similarity.
Manhattan Distance: Also known as L1 distance, this method calculates the sum of the absolute differences between the vector components. It can be useful when dealing with sparse embeddings.
Dot Product: A simple multiplication of the corresponding elements of the two vectors, which can be effective for normalized embeddings.
Semantic Similarity Metrics: Specialized metrics designed for code embeddings that take into account the unique characteristics of programming language semantics.
Neural Network Comparators: A small neural network may be trained to compare the two embeddings and output a similarity score, potentially capturing more complex relationships between the embeddings.
Ensemble Methods: Combining multiple comparison techniques to produce a more robust similarity measure.
Pearson Correlation Coefficient: This method may measure the linear correlation between the two embedding vectors, providing insight into how the dimensions of the embeddings relate to each other proportionally.
Spearman Rank Correlation: This approach may assess the monotonic relationship between the embeddings by comparing the rank orders of their components, which can be useful when the absolute values are less important than the relative ordering.
Wasserstein Distance (Earth Mover's Distance): This technique may measure the minimum cost required to transform one embedding distribution into another, providing a geometrically meaningful distance metric that considers the underlying structure of the embedding space.
Mahalanobis Distance: This method may account for the covariance structure of the embedding space, providing a distance measure that considers the correlations between different dimensions of the embeddings.
Jaccard Similarity: When embeddings are converted to binary or sparse representations, this approach may measure the similarity based on the intersection and union of non-zero elements.
Hamming Distance: For binary quantized embeddings, this technique may count the number of positions where the corresponding bits differ between the two embeddings.
KL Divergence (Kullback-Leibler Divergence): This method may measure the difference between two probability distributions derived from the embeddings, particularly useful when embeddings are normalized to represent probability distributions.
Jensen-Shannon Divergence: This approach may provide a symmetric version of KL divergence, offering a more balanced measure of distributional differences between embeddings.
Centered Kernel Alignment: This technique may measure the alignment between the kernel matrices derived from the embeddings, potentially capturing higher-order relationships.
Maximum Mean Discrepancy (MMD): This method may compare the mean embeddings in a reproducing kernel Hilbert space, providing a non-parametric test for distributional differences.

The comparison result 524 generated by the semantic comparison module 522 may take various forms, depending on the specific comparison method used and the desired output format. Examples of forms that the comparison result may take include any one or more of the following:
Scalar Similarity Score: A single numerical value representing the overall semantic similarity between the two embeddings. This may be a value between 0 and 1, where 1 indicates perfect similarity and 0 indicates complete dissimilarity.
Distance Metric: A numerical value representing the semantic distance between the two embeddings. In this case, a smaller value may indicate greater similarity.
Vector of Similarity Scores: If the comparison is performed component-wise or across different aspects of the embeddings, the result may be a vector of similarity scores, each representing the similarity for a specific feature or dimension.
Similarity Matrix: For hierarchical or structured embeddings, the result may be a matrix showing the pairwise similarities between different components or levels of the embeddings.
Categorical Classification: The result may be a categorical label indicating the degree of similarity, such as “High”, “Medium”, or “Low” semantic preservation.
Probability Distribution: The comparison result may be expressed as a probability distribution over different levels of similarity, providing a more nuanced view of the semantic preservation.
Confidence Score: In addition to a similarity measure, the result may include a confidence score indicating the reliability of the comparison, especially useful when dealing with complex or ambiguous code structures.

Embedding models may be trained specifically for the language of the input code 502 and the language of the cross-language generated code 516, allowing them to directly map code into the embedding space. This approach offers several advantages for the system 500. For example, by training embedding models tailored to specific programming languages, the system 500 may more efficiently convert code into semantic embeddings. This specialization allows for quicker processing of both the original input code 502 and the cross-language generated code 516, potentially improving the overall speed of the malicious code detection process.

Furthermore, language-specific embedding models may be designed to handle incomplete or partial code snippets effectively. This capability is particularly useful when analyzing code fragments, functions, or modules in isolation, without requiring the full context of the entire program. It enables the system 500 to perform targeted analysis on specific portions of the input code 502, which may be beneficial for identifying localized malicious patterns or antipatterns.

The system 500 as a whole, and particularly the semantic comparison module 522 and its comparison result 524 output, may be used to perform cross-language detection of malicious code in a variety of ways. For example, the semantic comparison module 522 may compare the transformed code embedding 512 (derived from the original input code 502) with the cross-language transformed code embedding 520 (derived from the cross-language generated code 516). This comparison allows the system 500 to assess how well the semantic meaning of the input code 502 is preserved across different programming languages.

Semantic inconsistencies may be quantified using various metrics and threshold-based approaches. For example, the system 500 may calculate a semantic similarity score using cosine similarity between the embeddings, where values below a predetermined threshold (such as 0.85, 0.80, 0.75, or 0.70) may indicate potential malicious alterations. In some embodiments, the system 500 may employ statistical measures such as standard deviation analysis, where deviations exceeding two or three standard deviations from a baseline distribution of legitimate code translations may be flagged as suspicious.

The system 500 may also implement scoring mechanisms that combine multiple distance metrics, such as Euclidean distance, Manhattan distance, and/or Wasserstein distance, to generate a composite anomaly score. Threshold values may be dynamically adjusted based on the specific programming language pairs being analyzed, with more sensitive thresholds applied to high-risk language combinations. Additionally, the system 500 may utilize machine learning-based classifiers trained on labeled datasets of benign and malicious code transformations to distinguish between normal translation variations and potential security threats, where classification confidence scores below predetermined levels (such as 0.90, 0.85, or 0.80) may trigger further investigation.

By analyzing the comparison result 524, the system 500 may identify patterns or structures that are consistent across different programming languages. These patterns may correspond to known malicious code signatures or behaviors. The ability to recognize these patterns regardless of the programming language may enhance the system 500's capability to detect malicious code that has been translated or obfuscated by changing languages.

Embodiments of the system 500 may build and maintain a comprehensive knowledge base of malicious patterns through various approaches, including machine learning techniques, pattern databases, and/or adaptive learning mechanisms. For example, the system 500 may employ supervised learning algorithms that are trained on labeled datasets containing examples of both malicious and benign code across multiple programming languages. These machine learning models may continuously update their understanding of malicious patterns as new threat data becomes available.

The system 500 may also maintain a dynamic pattern database that stores semantic embeddings of known malicious code signatures, where each signature may be represented as a high-dimensional vector that captures the essential characteristics of the malicious behavior. This database may be updated through automated threat intelligence feeds, manual analysis by security researchers, and/or community-driven contributions. Additionally, embodiments of the system 500 may implement adaptive learning mechanisms that enable the system to evolve its detection capabilities based on newly encountered threats. For instance, when the semantic comparison module 522 identifies a previously unknown pattern that exhibits characteristics similar to known malicious code, the system 500 may flag this pattern for further analysis and potentially incorporate it into the knowledge base after validation. The system 500 may also employ unsupervised learning techniques, such as clustering algorithms, to identify anomalous patterns in code embeddings that may indicate novel attack vectors or previously undetected malicious behaviors.

For example, the system 500 may determine whether there are semantic inconsistencies between the transformed code embedding 512 and the cross-language transformed code embedding 520 (and hence between the input code 502 and the cross-language generated code 516) based on the comparison result 524, and thereby determine whether there are actual or likely unauthorized modifications to the input code 502 or injections of malicious code in the input code 502. As another example, the system 500 may determine whether the comparison result 524 contains or otherwise indicates known malicious code signatures. The system 500 may flag any such malicious code signatures as a potential security threat.

The system 500 may incorporate non-code sources to enhance its malicious code detection capabilities across different programming languages. This ability allows the system 500 to accept and analyze natural language text, such as entries from the National Vulnerability Database (NVD) and MITRE, and compare them to code bases to generate similarity scores.

For example, any techniques that are disclosed herein in connection with the input code 502 may be applied to non-code sources, such as natural language text descriptions of vulnerabilities or threats. This allows for a broader range of inputs to be analyzed for potential security risks.

For example, the embedding module 510 may generate a semantic embedding for input code 502 that is in the form of natural language text. In this case, the embedding model(s) may be trained or fine-tuned to effectively capture the semantic meaning of textual descriptions of vulnerabilities. The output would still be a transformed code embedding 512, but it would represent the semantic essence of the text input rather than code.

The cross-language code generation module 514 may be adapted to generate code snippets or patterns based on the natural language description in the input code 502 and/or the transformed code embedding 512. Instead of translating between programming languages, the cross-language code generation module 514 may, for example, translate natural language vulnerability descriptions into representative code samples. The resulting output may be a form of cross-language generated code 516, but derived from text rather than source code.

The embedding module 510 may function similarly to the ways disclosed above, but may generate embeddings for the code snippets or patterns produced by the adapted cross-language generation module 514.

The semantic comparison module 522 may be enhanced to compare embeddings from different domains—the embedding of the original text input and the embedding of the generated code snippets. Similarity metrics or analysis techniques may be adapted to effectively measure the semantic relationship between textual descriptions of vulnerabilities and code implementations. The output would still be the comparison result 524.

The system 500's analysis of the comparison result 524 may be adapted to interpret similarity scores between text-based threat descriptions and code implementations. This may involve, for example, algorithms or heuristics that are adapted to identify potential matches between described vulnerabilities and actual code patterns.

By implementing the modules of the system 500 in these ways, the system 500 may effectively bridge the gap between natural language descriptions of vulnerabilities and code implementations, enhancing its capability to detect potential security threats across different representations of software vulnerabilities.

As a particular example of analyzing a non-text source, consider the following natural language rule, which may be used as the input code 502:“allows plaintext transmission of passwords.” The system 500 may apply the techniques disclosed herein to this natural language rule to identify similar patterns in actual code. For example, such techniques may determine that the following JavaScript code snippet matches the natural language rule:
fetch(http://example. com/? password=${password}, {headers});

The system 500's sensitivity may be adjusted based on the programming language being analyzed. This includes considerations for the original source language, compilation target, and current source language. For instance, the system system 500 may be configured to be more sensitive when matching JavaScript code that C code.

Furthermore, the distance thresholds for determining matches may be configured globally or on a per-rule basis. This allows for fine-tuning the system 500's sensitivity for different types of vulnerabilities or code patterns. These settings for language sensitivity and match thresholds may be applied globally across all rules or customized for individual rules or examples, providing a high degree of flexibility in how the system detects potential security issues.

This approach enables the system to bridge the gap between natural language descriptions of vulnerabilities and their manifestations in actual code, enhancing its ability to detect potential security threats across different programming languages and vulnerability types.

As yet further examples, the system 500 may be extended to analyze a wide range of data types beyond source code, including binary files and various media formats. This expansion significantly enhances the system 500's capability to detect malicious code and security vulnerabilities across different representations of data.

To implement such functionality, the system 500 may be adapted in any of a variety of ways. For example, the system 500 may be modified to examine binary files, such as executable files (.exe), even if they have been disguised as other file types (e.g., .jpg) or had their executable flags removed. This capability allows for detection of malicious code in compiled programs.

As another example, the system 500 may include an interpreting module for specific Assembly languages. This module would allow the system 500 to analyze low-level code structures in binary files, similar to how it processes high-level source code.

Even more generally, the embedding module 510 may be enhanced to generate semantic embeddings for a variety of data types, such as video, audio, text, source code, and images.

By implementing these enhancements, the system 500 may provide a comprehensive solution for detecting malicious code and security vulnerabilities across a wide range of data formats and representations. This expanded capability aligns with the system 500's core functionality of semantic analysis and comparison, extending its applicability to diverse scenarios in cybersecurity and software analysis.

The comparison result 524 generated by the semantic comparison module 522 may be utilized for various purposes in addition to and/or other than malicious code detection, extending the applicability of embodiments of the system 500 and method 600 to diverse software analysis scenarios.

Embodiments of the system 500 may leverage the semantic embedding and cross-language comparison techniques to identify code quality issues, programming antipatterns, and compliance violations across different programming languages. The comparison result 524 may reveal inefficient coding practices, maintainability issues, and deviations from coding standards regardless of the programming language used in the input code 502 or cross-language generated code 516.

For example, the system 500 may detect common antipatterns such as god objects, spaghetti code, or magic numbers by analyzing the semantic patterns captured in the transformed code embedding 512 and cross-language transformed code embedding 520. When the comparison result 524 indicates semantic inconsistencies that correspond to known quality issues, the system 500 may flag these patterns for developer attention. The cross-language analysis capability may be particularly valuable for organizations that maintain codebases in multiple programming languages, as it enables consistent quality assessment across diverse technology stacks.

The system 500 may also evaluate compliance with coding standards and best practices by comparing the comparison result 524 against established quality benchmarks. For instance, the semantic comparison module 522 may identify code structures that violate principles such as single responsibility, separation of concerns, or proper error handling across different programming languages. This capability may enable organizations to maintain consistent code quality standards regardless of the specific programming languages used by different development teams.

As described elsewhere in the Specification, embodiments of the invention may be particularly valuable for investors evaluating potential investments in software companies. The system 500 may assess the originality, quality, and technical debt of a company's codebase by analyzing semantic similarities and identifying potentially problematic code patterns across multiple programming languages.

The comparison result 524 may provide investors with quantitative metrics regarding the technical health of a target company's software assets. For example, when the semantic comparison module 522 identifies high similarity scores between the transformed code embedding 512 and cross-language transformed code embedding 520, this may indicate consistent implementation quality across different programming languages. Conversely, significant discrepancies in the comparison result 524 may suggest technical debt, inconsistent development practices, or potential maintenance challenges.

Embodiments of the system 500 may generate comprehensive technical assessment reports based on the comparison result 524, enabling investors to make informed decisions about the technological value and risks associated with potential acquisitions. The cross-language analysis capability may be particularly valuable when evaluating companies that have developed software using diverse technology stacks, as it provides a unified framework for assessing code quality across different programming paradigms.

Embodiments of the invention may be used to detect unauthorized copying or plagiarism of source code, including non-literal copying where code has been modified through variable renaming, formatting changes, or translation to different programming languages. The comparison result 524 may reveal semantic similarities that indicate potential intellectual property violations, even when the literal text of the code has been altered.

The system 500 may identify instances where proprietary algorithms or business logic have been copied and disguised through superficial modifications or language translation. For example, when the semantic comparison module 522 generates a comparison result 524 indicating high semantic similarity between the input code 502 and known copyrighted code patterns, this may suggest potential intellectual property infringement. The cross-language capabilities of the system 500 may be particularly valuable for detecting cases where copyrighted code has been translated from one programming language to another in an attempt to evade detection.

Embodiments of the system 500 may maintain databases of protected intellectual property patterns represented as semantic embeddings, enabling automated detection of potential violations across multiple programming languages. The comparison result 524 may provide evidence for legal proceedings by demonstrating semantic similarities that transcend superficial code modifications.

When organizations migrate code between programming languages or modernize legacy systems, embodiments of the invention may validate that the semantic meaning and functionality of the original code is preserved in the translated version. The cross-language comparison capabilities may identify discrepancies that could indicate translation errors or functional changes.

The comparison result 524 may serve as a quality assurance metric for code migration projects, where high similarity scores between the transformed code embedding 512 and cross-language transformed code embedding 520 may indicate successful preservation of semantic functionality. Conversely, significant discrepancies in the comparison result 524 may alert developers to potential translation errors that require further investigation.

For example, when migrating a legacy COBOL system to Java, the system 500 may compare the semantic embeddings of the original COBOL code with the translated Java implementation. The comparison result 524 may identify specific functions or modules where the translation process has introduced semantic changes, enabling developers to focus their validation efforts on the most critical areas.

Embodiments of the system 500 may analyze third-party libraries, dependencies, and open-source components to identify potential security risks, licensing issues, or code quality problems across different programming languages used in a software project. The comparison result 524 may reveal similarities between project code and known problematic patterns in external dependencies.

The system 500 may maintain databases of known vulnerable or problematic code patterns from popular open-source libraries and frameworks. When the semantic comparison module 522 generates a comparison result 524 indicating similarity between the input code 502 and these known patterns, the system 500 may flag potential supply chain security risks. This capability may be particularly valuable for organizations that use diverse technology stacks with dependencies spanning multiple programming languages.

Embodiments of the invention may be integrated into CI/CD pipelines to automatically analyze code commits, ensuring that new code meets quality standards and does not introduce problematic patterns, regardless of the programming language used by different development teams. The comparison result 524 may serve as an automated quality gate in the development workflow.

For example, the system 500 may be configured to analyze each code commit and generate a comparison result 524 that indicates the semantic quality and consistency of the new code. When the comparison result 524 reveals patterns that deviate significantly from established quality benchmarks, the CI/CD pipeline may automatically reject the commit or flag it for manual review. This automated quality assurance capability may help maintain consistent code standards across large development organizations with diverse programming language preferences.

For organizations developing software across multiple programming languages and platforms, embodiments of the invention may provide unified analysis capabilities that help maintain consistency in code quality, security practices, and architectural patterns across different language implementations. The comparison result 524 may identify discrepancies in implementation approaches that could affect system integration or maintenance.

The system 500 may analyze codebases that implement similar functionality across different programming languages, using the comparison result 524 to identify inconsistencies in architectural patterns, error handling approaches, or security implementations. This capability may enable development teams to maintain consistent design principles and implementation quality across diverse technology platforms.

Embodiments of the system 500 may be used in educational settings to help students and developers understand code patterns, identify common mistakes, and learn best practices across different programming languages by providing semantic analysis and comparison capabilities. The comparison result 524 may serve as a learning tool for understanding the semantic relationships between different programming constructs.

For example, educational institutions may use the system 500 to demonstrate how similar algorithms can be implemented across different programming languages, with the comparison result 524 providing quantitative measures of semantic similarity. Students may learn to recognize common programming patterns and antipatterns by analyzing how the comparison result 524 changes when code is modified in various ways. The cross-language capabilities of the system 500 may be particularly valuable for teaching programming language concepts and helping students understand the fundamental similarities and differences between different programming paradigms.

Embodiments of the present invention provide several advantages through the particular sequence of operations performed by the method 600 (FIG. 6). Referring to FIG. 6, the method 600 implements a dual-path analysis approach that may offer unique benefits for cross-language malicious code detection that are not achievable through conventional single-path analysis methods.

The dual transformation pathway employed by the method 600 may create a robust validation mechanism for semantic preservation across programming languages. By transforming the input code 502 into the transformed code 508 (FIG. 6, operation 604) and simultaneously generating the cross-language generated code 516 (FIG. 6, operation 608), embodiments of the invention may establish two independent analytical pathways that converge at the semantic comparison stage. This dual-path approach may enable the system 500 to detect subtle semantic alterations or malicious modifications that might remain undetected in single-transformation approaches.

The sequence of operations in the method 600 may provide enhanced obfuscation detection capabilities. When malicious code attempts to evade detection through language-specific obfuscation techniques, the cross-language transformation process may strip away language-dependent obfuscation layers while preserving the underlying malicious semantics. For example, variable name obfuscation in Python may be neutralized when the code is transformed through the intermediate representation in the transformed code 508 and then cross-translated into JavaScript in the cross-language generated code 516. The comparison between the transformed code embedding 512 and the cross-language transformed code embedding 520 (FIG. 6, operation 614) may reveal the persistent malicious patterns that survive the cross-language transformation process.

Embodiments of the method 600 may offer improved detection of polymorphic malware through the dual embedding comparison approach. Polymorphic malware may alter its surface appearance while maintaining its core functionality. The transformation of the input code 502 into both the transformed code 508 and the cross-language generated code 516 may create two different representations of the same underlying semantic content. When these representations are embedded into the transformed code embedding 512 and cross-language transformed code embedding 520 respectively, their comparison may reveal the invariant semantic structures that characterize the malicious behavior, regardless of the polymorphic variations applied to the original code.

The particular sequence implemented by the method 600 may enable detection of cross-language attack vectors that exploit language-specific vulnerabilities. For instance, a buffer overflow vulnerability implemented in C may manifest differently when translated to Python due to Python's automatic memory management. However, the semantic comparison between the transformed code embedding 512 and cross-language transformed code embedding 520 may identify discrepancies that indicate the presence of language-specific exploitation techniques that could be missed by single-language analysis approaches.

Embodiments of the method 600 may provide enhanced accuracy in distinguishing between legitimate code variations and malicious modifications. The dual-path analysis creates a semantic consistency check that may identify when code modifications serve malicious purposes rather than legitimate optimization or refactoring. For example, if the input code 502 contains legitimate performance optimizations, both the transformed code embedding 512 and cross-language transformed code embedding 520 may reflect similar semantic structures, resulting in high similarity scores in the comparison result 524. Conversely, if the input code 502 contains malicious injections, the cross-language transformation process may reveal semantic inconsistencies that indicate the presence of unauthorized code modifications.

The method 600 may offer improved scalability for analyzing large codebases through its intermediate representation approach. By transforming both the input code 502 and cross-language generated code 516 into standardized intermediate representations (the transformed code 508 and cross-language transformed code 518), embodiments of the invention may enable efficient batch processing of diverse programming languages using unified analytical frameworks. This standardization may reduce computational overhead compared to maintaining separate analysis pipelines for each programming language combination.

Embodiments of the method 600 may provide enhanced resistance to adversarial attacks designed to evade malicious code detection systems. Adversarial code may be crafted to exploit weaknesses in single-language detection systems by using language-specific features to mask malicious intent. However, the dual-path analysis implemented by the method 600 may create multiple analytical perspectives that adversarial code must simultaneously evade. The cross-language transformation process may expose malicious patterns that remain hidden in the original language representation, while the semantic comparison may identify inconsistencies that indicate adversarial manipulation.

The particular sequence of operations in the method 600 may enable detection of supply chain attacks that involve malicious code injection across different development environments. When malicious code is injected into a software project that uses multiple programming languages, the cross-language analysis approach may identify semantic inconsistencies between different language implementations of the same functionality. For example, if a malicious actor injects backdoor code into a Python module while leaving the corresponding JavaScript implementation clean, the comparison between the transformed code embedding 512 and cross-language transformed code embedding 520 may reveal the semantic discrepancy that indicates the presence of the injected malicious code.

Embodiments of the method 600 may offer improved detection of zero-day exploits through their semantic analysis approach. Zero-day exploits may use novel attack vectors that have not been previously cataloged in signature-based detection systems. However, the dual embedding comparison implemented by the method 600 may identify semantic patterns that are characteristic of malicious behavior, even when the specific attack vector is previously unknown. The cross-language transformation process may reveal the underlying malicious logic that persists across different programming language representations, enabling detection of zero-day exploits based on their semantic characteristics rather than their specific implementation details.

The method 600 may provide enhanced capability for detecting insider threats through its semantic consistency analysis. Insider threats may involve subtle modifications to legitimate code that introduce malicious functionality while maintaining the appearance of normal development activity. The dual-path analysis approach may identify semantic inconsistencies that indicate unauthorized code modifications, even when such modifications are designed to blend in with legitimate code changes. The comparison between the transformed code embedding 512 and cross-language transformed code embedding 520 may reveal discrepancies that suggest the presence of malicious modifications introduced by insider threats.

In one embodiment, a method is performed by at least one computer processor executing computer program instructions stored on at least one non-transitory computer-readable medium. The method includes identifying input text, producing first transformed code based on the input text, generating a first transformed code embedding based on the first transformed code, generating cross-language code based on the input text where the cross-language code is in a different programming language than the input text, producing second transformed code based on the cross-language code, generating a second transformed code embedding based on the second transformed code, comparing the first transformed code embedding to the second transformed code embedding to produce a comparison result, and determining based on the comparison result whether the input text includes malicious code.

In other embodiments, the input text may include input source code or text written in a natural language. The first transformed code may be produced in an intermediate representation that captures structure and semantics of the input text, where the intermediate representation may include WebAssembly (WASM), LLVM Intermediate Representation (LLVM IR), Java bytecode, or . NET Common Intermediate Language (CIL). The first transformed code may be produced by generating an Abstract Syntax Tree (AST) representation of the input text. The first transformed code embedding may be generated using an artificial neural network to convert the first transformed code into a high-dimensional vector representation, which may include a vector having at least 768 dimensions. The first transformed code embedding may be generated using a transformer-based model to generate contextual embeddings of the first transformed code. The cross-language code may be generated using a variational autoencoder to encode the input text into a latent space representation and decode the latent space representation into the cross-language code, where a loss function of the variational autoencoder may be defined as a semantic distance between the first transformed code embedding and the second transformed code embedding. The cross-language code may be generated using a neural machine translation model to translate the input text from a first programming language to a second programming language. The cross-language code may be generated by parsing the input text into an abstract syntax tree and transforming the abstract syntax tree into the cross-language code in the different programming language. The input text may be written in a first programming language selected from Python, JavaScript, Java, C++, and C or a natural language description, and the cross-language code may be written in a second programming language either the same or different from the first programming language and selected from Python, JavaScript, Java, C++, and C or a natural language description. The second transformed code may be produced in an intermediate representation that captures structure and semantics of the cross-language code, where the intermediate representation may include WebAssembly (WASM), LLVM Intermediate Representation (LLVM IR), Java bytecode, or . NET Common Intermediate Language (CIL). The second transformed code may be produced by generating an Abstract Syntax Tree (AST) representation of the cross-language code. The first transformed code and second transformed code may be produced using the same transformation technique, which may include converting both the input text and the cross-language code into the same intermediate representation format. The second transformed code embedding may be generated using a large language model to convert the second transformed code into a high-dimensional vector representation. The comparison may be performed by calculating a cosine similarity, Euclidean distance, Manhattan distance, or dot product between the first and second transformed code embeddings. The comparison result may include a distance metric representing semantic distance between the first transformed code embedding and the second transformed code embedding. The comparison may be performed using a neural network comparator to generate a similarity score between the first transformed code embedding and the second transformed code embedding. The comparison result may include a probability distribution over different levels of semantic similarity between the first transformed code embedding and the second transformed code embedding. The determination of whether the input text includes malicious code may include identifying semantic inconsistencies between the first transformed code embedding and the second transformed code embedding that exceed a predetermined threshold. The determination may include comparing the comparison result to known malicious code signatures stored in a database. The determination may include identifying patterns in the comparison result that correspond to known antipatterns. The determination may include calculating a maliciousness score based on the comparison result and comparing the maliciousness score to a threshold value. The determination may include using a machine learning classifier trained on labeled examples of malicious and benign code to analyze the comparison result.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention which perform fingerprinting cannot be performed mentally or manually by a human. For example, such embodiments include the generation and manipulation of high-dimensional vector embeddings from source code, which are used to capture the semantic essence of the code. This process involves complex mathematical computations and transformations that are only feasible with the computational power of modern processors. Additionally, the embeddings are stored in a vector database that utilizes specialized indexing techniques to facilitate efficient and scalable searches. These operations require significant processing power and memory management capabilities that exceed human cognitive abilities and manual processing methods. Furthermore, the comparison of these semantic embeddings using metrics such as cosine similarity involves calculating distances or angles between high-dimensional vectors. This task not only demands computational accuracy but also the ability to handle large volumes of data at high speeds, which can only be achieved through automated systems designed for such purposes.

Embodiments of the system 500 provide a technological solution to a technical problem in the field of software security and malicious code detection. Embodiments of the system 500 go beyond abstract ideas or mere mental processes by implementing a complex system that leverages advanced computational techniques to analyze and compare code across different programming languages and data formats. For example, embodiments of the system 500 enhance the functionality of computer systems within the software development industry by addressing the challenge of detecting malicious code across different programming languages and data formats. The system 500 overcome limitations of traditional methods by employing computer-automated semantic analysis techniques, thereby substantially improving the computer's ability to process and analyze source code in ways that were previously unattainable. The system 500 also transforms input data (source code, natural language text, or other formats) into semantic embeddings, which represent a new and functionally distinct form. This transformation is not merely a reformatting of data but a substantive conversion that encapsulates the semantic essence of the input in a high-dimensional vector space. The transformed data is then utilized for advanced detection of security vulnerabilities and malicious code, which traditional methods struggle to identify effectively.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method performed by at least one computer processor executing computer program instructions stored on at least one non-transitory computer-readable medium, the method comprising:
identifying input text;
producing first transformed code based on the input text;
generating a first transformed code embedding based on the first transformed code;
generating cross-language code based on the input text, wherein the cross-language code is in a different programming language than the input text;
producing second transformed code based on the cross-language code;
generating a second transformed code embedding based on the second transformed code;
comparing the first transformed code embedding to the second transformed code embedding to produce a comparison result; and
determining, based on the comparison result, whether the input text includes malicious code.

2. The method of claim 1, wherein the input text comprises input source code.

3. The method of claim 1, wherein producing the first transformed code based on the input text comprises producing the first transformed code in an intermediate representation that captures structure and semantics of the input text.

4. The method of claim 3, wherein the intermediate representation comprises one selected from the group consisting of WebAssembly (WASM), LLVM Intermediate Representation (LLVM IR), Java bytecode, and .NET Common Intermediate Language (CIL).

5. The method of claim 1, wherein generating the first transformed code embedding based on the first transformed code comprises using an artificial neural network to convert the first transformed code into a high-dimensional vector representation.

6. The method of claim 5, wherein the high-dimensional vector representation comprises a vector having at least 768 dimensions.

7. The method of claim 1, wherein generating the first transformed code embedding based on the first transformed code comprises using a transformer-based model to generate contextual embeddings of the first transformed code.

8. The method of claim 1, wherein the comparison result comprises a distance metric representing semantic distance between the first transformed code embedding and the second transformed code embedding.

9. The method of claim 1, wherein comparing the first transformed code embedding to the second transformed code embedding comprises using a neural network comparator to generate a similarity score between the first transformed code embedding and the second transformed code embedding.

10. The method of claim 1, wherein determining whether the input text includes malicious code comprises using a machine learning classifier trained on labeled examples of malicious and benign code to analyze the comparison result.

11. A system comprising at least one non-transitory computer-readable medium having computer program instructions stored thereon, the computer program instructions being executable by at least one computer processor to perform a method, the method comprising:
identifying input text;
producing first transformed code based on the input text;
generating a first transformed code embedding based on the first transformed code;
generating cross-language code based on the input text, wherein the cross-language code is in a different programming language than the input text;
producing second transformed code based on the cross-language code;
generating a second transformed code embedding based on the second transformed code;
comparing the first transformed code embedding to the second transformed code embedding to produce a comparison result; and
determining, based on the comparison result, whether the input text includes malicious code.

12. The system of claim 11, wherein the input text comprises input source code.

13. The system of claim 11, wherein producing the first transformed code based on the input text comprises producing the first transformed code in an intermediate representation that captures structure and semantics of the input text.

14. The system of claim 13, wherein the intermediate representation comprises one selected from the group consisting of WebAssembly (WASM), LLVM Intermediate Representation (LLVM IR), Java bytecode, and . NET Common Intermediate Language (CIL).

15. The system of claim 11, wherein generating the first transformed code embedding based on the first transformed code comprises using an artificial neural network to convert the first transformed code into a high-dimensional vector representation.

16. The system of claim 15, wherein the high-dimensional vector representation comprises a vector having at least 768 dimensions.

17. The system of claim 11, wherein generating the first transformed code embedding based on the first transformed code comprises using a transformer-based model to generate contextual embeddings of the first transformed code.

18. The system of claim 11, wherein the comparison result comprises a distance metric representing semantic distance between the first transformed code embedding and the second transformed code embedding.

19. The system of claim 11, wherein comparing the first transformed code embedding to the second transformed code embedding comprises using a neural network comparator to generate a similarity score between the first transformed code embedding and the second transformed code embedding.

20. The system of claim 11, wherein determining whether the input text includes malicious code comprises using a machine learning classifier trained on labeled examples of malicious and benign code to analyze the comparison result.
